(19) United States
(12) Patent Application Publication
(10) Pub. No.: US 2025/0313214 A1
(43) Pub. Date: Oct. 9, 2025

(54) TRAVEL-DATA-PROCESSING DEVICE, TRAVEL-DATA-MEASURING DEVICE, AND TRAVEL-DATA MEASUREMENT-PROCESSING DEVICE

(71) Applicant: YAMAHA HATSUDOKI KABUSHIKI KAISHA, Iwata-shi (JP)

(72) Inventors: Shogo INUI, Shizuoka (JP); Kosuke URUSHIHARA, Shizuoka (JP)

(21) Appl. No.: 19/240,391

(22) Filed: Jun. 17, 2025

Related U.S. Application Data
(63) Continuation-in-part of application No. PCT/JP2022/046943, filed on Dec. 20, 2022.

(51) Int. Cl. B60W 40/09

(52) U.S. Cl. CPC B60W 40/09; B60W 2756/10

(57) ABSTRACT

A travel-data-processing device, including a memory storing a plurality of pieces of straight-line-travel-detailed-evaluation-related information and turning-travel-detailed-evaluation-related information, and a travel data processor outputting at least one of the plurality of pieces of straight-line-travel-detailed-evaluation-related information or turning-travel-detailed-evaluation-related information, based on an output of a detection device. The memory stores a plurality of pieces of straight-line-travel-simple-evaluation-related information and a plurality of pieces of turning-travel-simple-evaluation-related information. The travel data processor is configured to: acquire and segment travel data into straight-line-travel data and turning-travel data, evaluate a predetermined straight-line-travel-simple-evaluation item and a predetermined turning-travel-simple-evaluation item based on the straight-line-travel data and the turning travel data, respectively, evaluate a plurality of the straight-line-travel-detailed-evaluation items and a plurality of turning-travel-detailed-evaluation items based on the straight-line-travel data and the turning travel data, respectively, and select a detailed evaluation item and output a piece of detailed-evaluation-related information based on an evaluation result of the selected detailed evaluation item.

### CROSS-REFERENCES TO RELATED APPLICATIONS

This is a continuation-in-part application of International Application No. PCT/JP2022/046943, filed on Dec. 20, 2022, the contents of which are incorporated herein by reference.

### TECHNICAL FIELD

The present teaching relates to a travel-data-processing device, a travel-data-measurement device, and a travel-data-measurement-processing device.

### BACKGROUND ART

Conventionally, a travel-data-processing device that outputs comments on the driving skills of a mobile body's driver is known. Patent Document 1 discloses an evaluation system that scores the driving skills of a driver for each scoring item by comparing the driver with a population of drivers based on measurement data, such as a vehicle's position, orientation, acceleration, and jerk. The evaluation system displays a plurality of items, such as handling, braking, cornering, turning, jerk, and speed, as well as scores and comments for each scoring item, on a single screen.

Patent Document 2 discloses a riding simulator capable of accurately diagnosing the degree of improvement in driving skills by comparing travel results in different courses. The riding simulator uses an advice creation section to create advice tailored to a trainee for each training scene by combining various sentences prepared in advance.

Patent Document 3 discloses a driving training result evaluation system that can be used to improve the safe driving skills of a trainee by outputting a training result sheet that indicates details of the trainee's driving operation and includes appropriate advice. The driving training result evaluation system uses an advice creation section to create advice corresponding to the judgment result of each scoring scene by combining various sentences prepared in advance.

### CITATION LIST

### Patent Document

Patent Document 1: U.S. Patent Application Publication No. 2019066535
Patent Document 2: Japanese Patent No. 5328758
Patent Document 3: Japanese Patent No. 3761484

### SUMMARY OF INVENTION

### Technical Problem

In Patent Document 1, comments for each of numerous items are output to encourage improvement in a driver's driving skills. In Patent Documents 2 and 3, comments for each of numerous driving scenes are output to encourage improvement in a driver's driving skills. Furthermore, the travel-data-processing devices of Patent Documents 1 to 3 process a large amount of data because they generate comments based on information on various driving operations and information on various vehicle behaviors for each driving scene. In other words, the data processing devices of Patent Documents 1 to 3 require powerful hardware resources, such as high-performance processors and large-capacity memory. Therefore, the design flexibility of hardware resources of the travel-data-processing devices of Patent Documents 1 to 3 is low.

To address such an issue, there is a demand for a travel-data-processing device for a leaning vehicle or similar devices that can suppress the decrease in the design flexibility of hardware resources, such as processors and memory, even when the device is configured to output comments for encouraging improvement in the driving skills of a driver of a mobile body.

It is an object of the present teaching to provide a travel-data-processing device, a travel-data-measurement device, and a travel-data-measurement-processing device configured to output comments for encouraging improvement in the driving skills of a driver of a mobile body, wherein the decrease in design flexibility of hardware resources, such as processors and memory, can be suppressed.

### Solution to Problem

The inventors of the present teaching have studied in detail a travel-data-processing device, a travel-data-measurement device, and a travel-data-measurement-processing device configured to output comments for encouraging improvement in the driving skills of a driver of a mobile body, wherein the decrease in design flexibility of hardware resources, such as processors and memory, can be suppressed.

As a result of diligent study, the inventors have arrived at the following configuration.

A travel-data-processing device according to one embodiment of the present teaching comprises: a memory configured to store a plurality of pieces of straight-line-travel-detailed-evaluation-related information related to evaluations of a plurality of straight-line-travel-detailed-evaluation items, for evaluation of driving skills of a driver as exhibited during straight-line travel of a mobile body, and a plurality of pieces of turning-travel-detailed-evaluation-related information related to evaluations of a plurality of turning-travel-detailed-evaluation items, for evaluation of the driving skills of the driver as exhibited during turning travel of the mobile body; and a travel data processor configured to output at least one of the plurality of pieces of straight-line-travel-detailed-evaluation-related information or the plurality of pieces of turning-travel-detailed-evaluation-related information, based on an output of a detection device configured to be mounted on the mobile body and to detect a physical quantity related to a behavior of the mobile body.

The memory is further configured to store a plurality of pieces of straight-line-travel-simple-evaluation-related information related to evaluations of a plurality of straight-line-travel-simple-evaluation items, for evaluation of the driving skills of the driver as exhibited during the straight-line travel of the mobile body, and a plurality of pieces of turning-travel-simple-evaluation-related information related to evaluations of a plurality of turning-travel-simple-evaluation items, for evaluation of the driving skills of the driver as exhibited during the turning travel of the mobile body. The travel data processor is further configured to acquire travel data representing the physical quantity related to the behavior of the mobile body output from the detection device, and segment the travel data into straight-line-travel data for the straight-line travel of the mobile body and turning-travel data for the turning travel of the mobile body. The travel data processor is configured to evaluate a predetermined straight-line-travel-simple-evaluation item based on the straight-line-travel data, and output straight-line-travel-simple-evaluation-related information selected from among the plurality of pieces of the straight-line-travel-simple-evaluation-related information stored in the memory, based on the evaluation result. The travel data processor is configured to evaluate a predetermined turning-travel-simple-evaluation item based on the turning travel data, and output turning-travel-simple-evaluation-related information selected from among the plurality of pieces of the turning-travel-simple-evaluation-related information stored in the memory, based on the evaluation result. The travel data processor is configured to evaluate the plurality of the straight-line-travel-detailed-evaluation items for the straight-line travel of the mobile body based on the straight-line-travel data. The travel data processor is configured to evaluate the plurality of the turning-travel-detailed-evaluation items for the turning travel of the mobile body based on the turning travel data. The travel data processor is configured to select a detailed evaluation item, with an evaluation result that satisfies a predetermined condition, among the plurality of the straight-line-travel-detailed-evaluation items and the plurality of the turning-travel-detailed evaluation items, and output a piece of detailed-evaluation-related information, from among the plurality of pieces of the straight-line-travel-detailed-evaluation-related information and the plurality of pieces of the turning-travel-detailed-evaluation-related information stored in the memory, based on the evaluation result of the selected detailed evaluation item.

In the configuration described above, the travel-data-processing device evaluates the driver's driving skills as exhibited during straight-line travel and turning travel of the mobile body, using the predetermined straight-line-travel-simple-evaluation item and turning-travel-simple-evaluation item that the driver wishes to have evaluated. In addition, the travel data processing device evaluates the driver's driving skills as exhibited in various travel states of the mobile body from a plurality of aspects, using the plurality of straight-line-travel-detailed-evaluation items and the plurality of turning-travel-detailed-evaluation items. Furthermore, the travel-data-processing device selects a detailed evaluation item that satisfies a predetermined condition, and outputs evaluation-related information corresponding to the selected detailed evaluation item. This enables the output of the evaluation-related information from multiple perspectives, for predetermined evaluation items that the driver of the mobile body intentionally wishes to have evaluated and various evaluation items that are evaluated independently of the driver's intention.

In addition, the travel-data-processing device selects the evaluation result that satisfies the predetermined condition based on the plurality of detailed evaluation items, and outputs the detailed-evaluation-related information to be displayed, in a limited fashion, among the plurality of pieces of detailed-evaluation-related information, thereby reducing the amount of data processed by the travel data processor.

This enables a configuration that outputs the evaluation-related information for encouraging improvement in the driving skills of the driver of the mobile body, wherein the decrease in design flexibility of hardware resources, such as the travel data processor and the memory, can be suppressed.

In another aspect, the travel-data-processing device according to the present teaching may have the following configuration. The travel data processor is further configured to select the straight-line-travel-simple-evaluation-related information and the turning-travel-simple-evaluation-related information to include simple-evaluation-related information that indicates a high evaluation and simple-evaluation-related information that indicates a low evaluation, according to predetermined evaluation indices, based on evaluation results of the straight-line-travel-simple-evaluation items and evaluation results of the turning-travel-simple-evaluation items. Alternatively, the travel data processor is configured to select the detailed evaluation items to include detailed-evaluation-related information that indicates a higher evaluation than a threshold value and detailed-evaluation-related information that indicates a lower evaluation than the threshold value, according to predetermined evaluation indices, based on evaluation results that satisfy the predetermined condition among the evaluation results of the plurality of the straight-line-travel-detailed-evaluation items and the evaluation results of the plurality of the turning-travel-detailed evaluation items.

In the configuration described above, in order to encourage improvement in the driver's driving skills while suppressing the decline in the driver's motivation, the output is limited to the simple-evaluation-related information that indicates a high evaluation and the simple-evaluation-related information that indicates a low evaluation according to the predetermined evaluation indices, or the detailed-evaluation-related information that indicates a high evaluation and the detailed-evaluation-related information that indicates a low evaluation according to the predetermined evaluation indices. This enables a configuration that outputs the evaluation-related information for encouraging improvement in the driving skills of the driver of the mobile body, wherein the decrease in design flexibility of hardware resources, such as the travel data processor and the memory, can be suppressed.

In another aspect, the travel-data-processing device according to the present teaching may have the following configuration. The memory is further configured to store straight-line-travel-detailed-evaluation-related information that indicates a higher evaluation than a threshold value thereof and straight-line travel-detailed-evaluation-related information that indicates a lower evaluation than the threshold value thereof according to a predetermined evaluation index, for each of the straight-line-travel-detailed-evaluation items, and turning-travel-detailed-evaluation-related information that indicates a higher evaluation than a threshold value thereof and turning-travel-detailed-evaluation-related information that indicates a lower evaluation than the threshold value thereof according to a predetermined evaluation index, for each of the turning-travel-detailed-evaluation items.

In the configuration described above, it is possible to output either the evaluation-related information that indicates a high evaluation or the evaluation-related information that indicates a low evaluation according to the predetermined evaluation index, for each evaluation item among the plurality of straight-line-travel-detailed-evaluation items and the plurality of turning-travel-detailed-evaluation items. This enables a configuration that outputs the evaluation-related information for encouraging improvement in the driving skills of the driver of the mobile body, wherein the decrease in design flexibility of hardware resources, such as the travel data processor and the memory, can be suppressed.

In another aspect, the travel-data-processing device according to the present teaching may have the following configuration. The predetermined condition is defined as a highest evaluation and a lowest evaluation, among evaluation results of the plurality of the straight-line-travel-detailed-evaluation items and evaluation results of the plurality of the turning-travel-detailed-evaluation items.

In the configuration described above, the evaluation-related information corresponding to the evaluation item with the highest evaluation result of the driver's driving skill and the evaluation-related information corresponding to the evaluation item with the lowest evaluation result of the driver's driving skill are selected from among the plurality of straight-line-travel-detailed-evaluation items and the plurality of turning-travel-detailed-evaluation items, so that the evaluation-related information for encouraging improvement in driving skills is output while suppressing the decline in the driver's motivation, with a reduced amount of data processed by the travel data processor. This enables a configuration that outputs the evaluation-related information for encouraging improvement in the driving skills of the driver of the mobile body, wherein the decrease in design flexibility of hardware resources, such as the travel data processor and the memory, can be suppressed.

In another aspect, the travel-data-processing device according to the present teaching may have the following configuration. The straight-line-travel-simple-evaluation-related information, the turning-travel-simple-evaluation-related information, the straight-line-travel-detailed-evaluation-related information, and the turning-travel-detailed-evaluation-related information include at least two types of information selected from among a speed range of the mobile body, a driving scene of the mobile body, or an operation of the mobile body.

In the aforementioned configuration, the simple-evaluation-related information and the detailed-evaluation-related information, which define the travel state of the mobile body by a combination of the speed range of the mobile body, the driving scene of the mobile body, and the operation of the mobile body, are displayed, thereby reducing the amount of data processed by the travel data processor. In addition, the driving skills of the driver of the mobile body can be evaluated from multiple perspectives. This enables a configuration that outputs the evaluation-related information on driving skills to encourage improvement in the driving skills of the driver of the mobile body, wherein the decrease in design flexibility of hardware resources, such as the travel data processor and the memory, can be suppressed.

In another aspect, the travel-data-processing device according to the present teaching may have the following configuration. The travel data processor is configured to evaluate the plurality of the straight-line-travel-detailed-evaluation items and the plurality of the turning-travel-detailed-evaluation items through relative evaluation with respect to a predetermined population, based on the travel data.

In the configuration described above, the plurality of straight-line-travel-detailed-evaluation items and the plurality of turning-travel-detailed-evaluation items are evaluated, for example, relative to a population that is a set of evaluation results of the detailed evaluation items for a plurality of drivers. Therefore, the evaluation-related information is selected for the driver, based on the evaluation results of a population with various driving skill levels, so that the evaluation-related information for encouraging improvement in the driver's driving skills can be output.

In another aspect, a travel-data-measurement device according to the present teaching may have the following configuration. The travel-data-measurement device is configured to measure travel data of the mobile body to be processed by the travel-data-processing device. The travel-data-measurement device comprises: the detection device configured to be mountable on the mobile body and to detect the physical quantity related to the behavior of the mobile body; and a travel-data-measurement processor, configured to acquire the travel data from the detection device, and to output the acquired travel data in a format that is accessible to the travel data processor of the travel-data-processing device.

In the configuration described above, the travel data processor evaluates the plurality of straight-line-travel-detailed-evaluation items and the plurality of turning-travel-detailed-evaluation items based on the travel data acquired from the travel-data-measurement processor. In other words, the acquisition of the travel data and the processing of the travel data are respectively performed by the travel-data-measurement processor and the travel data processor. This enables the suppression of the decrease in design flexibility of hardware resources, such as the travel data processor and the memory.

In another aspect, the travel-data-measurement device according to the present teaching may have the following configuration. The travel-data-measurement device further comprises a communication device for external communications. The travel-data-measurement processor is configured to output the acquired travel data via the communication device.

In the configuration described above, the travel data detected by the travel-data-measurement device mounted on the mobile body is processed by the travel-data-processing device configured by an arithmetic processing unit and the like, outside the travel-data-measurement device. This enables the suppression of the decrease in design flexibility of hardware resources, such as the travel data processor and the memory.

In another aspect, the travel-data-processing device according to the present teaching may have the following configuration. The travel-data-processing device further comprises a communication device for external communications. The travel data processor is configured to acquire the travel data via the communication device.

In the configuration described above, the travel data is acquired from the travel-data-measurement device mounted on the mobile body, and is processed by the travel-data-processing device that is an arithmetic processing unit outside the travel data measurement device. This enables the suppression of the decrease in design flexibility of hardware resources, such as the travel data processor and the memory.

In another aspect, a travel-data-measurement-processing device according to the present teaching may have the following configuration. The travel-data-measurement-processing device comprises a travel-data-processing device, which includes: a memory configured to store a plurality of pieces of straight-line-travel-detailed-evaluation-related information related to evaluations of a plurality of straight-line-travel-detailed-evaluation items, for evaluation of driving skills of a driver as exhibited during straight-line travel of a mobile body, and a plurality of pieces of turning-travel-detailed-evaluation-related information related to evaluations of a plurality of turning-travel-detailed-evaluation items, for evaluation of the driving skills of the driver as exhibited during turning travel of the mobile body; and a travel data processor configured to output at least one of the plurality of pieces of straight-line-travel-detailed-evaluation-related information or the plurality of pieces of turning-travel-detailed-evaluation-related information, based on an output of a detection device configured to be mounted on the mobile body and to detect a physical quantity related to a behavior of the mobile body. The memory is further configured to store a plurality of pieces of straight-line-travel-simple-evaluation-related information related to evaluations of a plurality of straight-line-travel-simple-evaluation items, for evaluation of the driving skills of the driver as exhibited during the straight-line travel of the mobile body, and a plurality of pieces of turning-travel-simple-evaluation-related information related to evaluations of a plurality of turning-travel-simple-evaluation items, for evaluation of the driving skills of the driver as exhibited during the turning travel of the mobile body. The travel data processor is further configured to: acquire travel data representing the physical quantity related to the behavior of the mobile body output from the detection device, and segment the travel data into straight-line-travel data for the straight-line travel of the mobile body and turning-travel data for the turning travel of the mobile body; evaluate a predetermined straight-line-travel-simple-evaluation item based on the straight-line-travel data, and output straight-line-travel-simple-evaluation-related information selected from among the plurality of pieces of the straight-line-travel-simple-evaluation-related information stored in the memory, based on the evaluation result; evaluate a predetermined turning-travel-simple-evaluation item based on the turning travel data, and output turning-travel-simple-evaluation-related information selected from among the plurality of pieces of the turning-travel-simple-evaluation-related information stored in the memory, based on the evaluation result; evaluate the plurality of the straight-line-travel-detailed-evaluation items for the straight-line travel of the mobile body based on the straight-line-travel data; evaluate the plurality of the turning-travel-detailed-evaluation items for the turning travel of the mobile body based on the turning travel data; and select a detailed evaluation item, with an evaluation result that satisfies a predetermined condition, among the plurality of the straight-line-travel-detailed-evaluation items and the plurality of the turning-travel-detailed evaluation items, and output a piece of detailed-evaluation-related information, from among the plurality of pieces of the straight-line-travel-detailed-evaluation-related information and the plurality of pieces of the turning-travel-detailed-evaluation-related information stored in the memory, based on the evaluation result of the selected detailed evaluation item. The travel-data-measurement-processing device further comprises a travel-data-measurement device configured to measure the travel data, the travel-data-measurement device including: the detection device; and a travel-data-measurement processor, configured to acquire the travel data from the detection device, and to output the acquired travel data in a format that is accessible to the travel data processor, The travel data processor and the travel-data-measurement processor are configured as a single processor that is electrically connected to the memory and is housed in an enclosure mounted on the mobile body.

In the configuration described above, the travel-data-measurement-processing device acquires time-series data of the mobile body and processes the time-series data using the single processor, thereby improving the efficiency of the computational processing. In addition, the travel-data-measurement-processing device evaluates the driver's driving skills exhibited in various travel states of the mobile body, using the plurality of straight-line-travel-detailed-evaluation items and the plurality of turning-travel-detailed-evaluation items. Furthermore, the travel-data-measurement-processing device outputs evaluation-related information corresponding to the detailed evaluation item that satisfies the predetermined condition. This enables the output of the evaluation-related information on driving skills to encourage improvement in the driving skills of the driver of the mobile body, from multiple perspectives, while also improving the efficiency of the computational processing.

In addition, the travel-data-processing device selects, and outputs, the detailed-evaluation-related information corresponding to the evaluation result that satisfies the predetermined condition, from among the plurality of detailed evaluation items, thereby reducing the amount of data processed by the travel data processor.

This enables a configuration that outputs the evaluation-related information for encouraging improvement in the driving skills of the driver of the mobile body by the single processor, wherein the decrease in design flexibility of hardware resources, such as the travel data processor and the memory, can be suppressed.

The terminology used herein is for the purpose of describing particular embodiments only and is not intended to be limiting of the invention.

As used herein, the term “and/or” includes any and all combinations of one or more of the associated listed items.

It will be further understood that the terms “including,” “comprising” or “having” and variations thereof when used in this specification specify the presence of stated features, steps, operations, elements, components, and/or their equivalents, but do not preclude the presence or addition of one or more steps, operations, elements, components, and/or groups thereof.

It will be further understood that the terms “mounted,” “connected,” “coupled,” and/or their equivalents are used broadly and encompass both direct and indirect mounting, connecting and coupling. Further, “connected” and “coupled” are not restricted to physical or mechanical connections or couplings, and can include electrical connections or couplings, whether direct or indirect.

Unless otherwise defined, all terms (including technical and scientific terms) used herein have the same meaning as commonly understood by one having ordinary skill in the art to which this invention belongs.

It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the invention.

Embodiments of a travel-data-processing device, a travel-data-measurement device, and a travel-data-measurement-processing device according to the present teaching will be herein described.

In the following description, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

### [Leaning Vehicle]

A leaning vehicle herein is a vehicle that turns in a leaning posture. Specifically, the leaning vehicle is a vehicle that leans leftward when turning to left and leans rightward when turning to right in a left-right direction of the vehicle. The leaning vehicle may be a single-seat vehicle or may be configured to accommodate a plurality of passengers. The leaning vehicle includes two-wheeled vehicles as well as three-wheeled or four-wheeled vehicles, and the like. In other words, the leaning vehicle is not limited in terms of the number of wheels or whether it has wheels, and includes all types of vehicles that turn in a leaning posture. The leaning vehicle also includes scooters and the like.

### [Mobile Body]

A mobile body herein refers to a device equipped with a traveling mechanism for moving through space. The traveling mechanism includes devices driven by human power and devices equipped with a power unit, such as an engine and a motor. The mobile body may have wheels as its traveling mechanism or may be configured without wheels. The mobile body includes ground mobile bodies, waterborne mobile bodies, underwater mobile bodies, and aerial mobile bodies. The mobile body includes those driven by a pilot or a driver as well as those moving autonomously.

The ground mobile body includes two-wheeled vehicles (e.g., motorcycles and bicycles) and four-wheeled vehicles (e.g., automobiles). The ground mobile body also includes devices equipped with wheels, endless tracks, or other ground traveling mechanisms. The ground mobile body also includes snow bikes that move on snow. The ground mobile body may, for example, be equipped with a traveling mechanism other than wheels, such as ski boards.

The waterborne mobile body includes small and large vessels. The waterborne mobile body also includes mobile bodies that move on the sea.

The underwater mobile body includes submarines and remotely operated vehicles (ROVs).

The aerial mobile body includes aircraft, and unmanned aerial vehicles such as so-called drones.

The mobile body also includes artificial satellites or spacecraft that move in a satellite orbit within a gravitational field.

In particular, the mobile body herein may sometimes refer to a mobile body which moves in a single direction and in which gravity acts downward along the mobile body's vertical axis in a state of straight-line travel at the start of movement and the end of the movement.

### [Three Coordinate Axes]

Three coordinate axes herein refer to the three axes of the X-axis, Y-axis, and Z-axis that are orthogonal to each other. The three coordinate axes are the coordinate axes when a reference target is located at the origin. For example, the coordinate system of a sensor is constituted by the three coordinate axes defined with respect to the sensor. For example, the coordinate system of the mobile body is constituted by the three coordinate axes defined with respect to the mobile body. In the case of the mobile body, the three coordinate axes are also respectively referred to as the roll axis that extends in the front-rear direction relative to the vehicle, the pitch axis that extends in the left-right direction relative to the vehicle, and the yaw axis that extends in the vertical direction relative to the vehicle.

### [Physical Quantity Related to a Behavior of the Mobile Body]

A physical quantity related to a behavior of the mobile body herein refers to a physical quantity that changes due to the posture or behavior of the mobile body. The physical quantity related to the behavior of the mobile body includes at least one of speed, acceleration, deceleration, angle, angular velocity, or angular acceleration, wherein the speed, acceleration, and deceleration are physical quantities measured along the three axes of the mobile body (“front-rear direction,” “left-right direction,” and “up-down direction”), while the angle, angular velocity, and angular acceleration are physical quantities measured about the three axes (roll axis, yaw axis, and pitch axis).

### [Physical Quantity]

A physical quantity herein refers to a quantity that includes at least one of a physical quantity related to a roll motion, a physical quantity related to a yaw motion, or a physical quantity related to a pitch motion for the mobile body, which is acquired while the mobile body is traveling. The physical quantity is data that includes, for at least one of the roll motion, the yaw motion, or the pitch motion, at least one of speed, acceleration, jerk, angle, angular velocity, angular acceleration, or position information, for example.

### [Travel Data]

Travel data herein is data related to the movement of the mobile body. The travel data is continuous data for a certain period or longer. The travel data includes data based on the output of a sensor for detecting the physical quantity related to the behavior of the mobile body. The travel data may include at least one of mobile-body-driving-input data related to a driving input to the mobile body by a driver, mobile-body-behavior data related to the behavior of the mobile body, mobile-body-location data related to the mobile body's position during movement, or mobile-body-travel-environment data related to the environment in which the mobile body moves. The travel data includes straight-line-travel data and turning travel data.

### [Time-Series Travel Data]

Time-series travel data herein refers to travel data that is output in a time-series manner. The time-series travel data includes information that is a combination of travel data and the time at which the travel data was output.

### [Straight-Line-Travel Data]

Straight-line-travel data herein is travel data related to the straight-line travel of the mobile body. The straight-line-travel data is data for a certain period or longer. The straight-line-travel data is data concerning a physical quantity related to the straight-line travel of the mobile body, wherein the data is extracted from the travel data over a spatial segment or during a time period in which the mobile body is traveling in a straight line.

### [Turning Travel Data]

Turning travel data herein is travel data related to the turning travel of the mobile body. The turning travel data is data for a certain period or longer. The turning travel data is data concerning a physical quantity related to the turning travel of the mobile body, wherein the data is extracted from the travel data over a spatial segment or during a time period in which the mobile body is turning.

### [Turning Travel]

In the present teaching, turning travel is an action in which the mobile body changes its direction of travel in such a manner that a curve is drawn. In the present teaching, the turning travel may be a turning action for cornering or a turning action for steady state circular turning.

### [Driving Scene]

A driving scene herein refers to a travel state of the mobile body when it is traveling in a straight line, such as stopping, starting, accelerating, decelerating, emergency deceleration, and emergency avoidance, as well as the travel state of the mobile body when it is turning, such as traveling along a curve, start-up right or left turn, right or left turn after deceleration, start-up U-turn, traveling through the entire corner, corner entry, cornering, corner exit, reversal maneuver in consecutive corners, and emergency deceleration during turning.

### [Straight-Line-Travel-Simple-Evaluation Item]

In the present teaching, straight-line-travel-simple-evaluation item (simple evaluation item for straight-line travel) refers to a predetermined evaluation item for the driving skill that a driver exhibits during the mobile body's straight-line travel and wishes to have evaluated. The straight-line-travel-simple-evaluation item is used to evaluate a predetermined physical quantity included in the travel data of the mobile body during straight-line travel, based on a predetermined evaluation index, in order to evaluate the driver's driving skill as exhibited during the straight-line travel. The straight-line-travel-simple-evaluation items include at least one evaluation item. Straight-line-travel-simple-evaluation-related information (simple evaluation-related information for straight-line travel) on the driver's driving skill is assigned to the straight-line-travel-simple-evaluation item, based on the predetermined evaluation index. The straight-line-travel-simple-evaluation item may be defined, for example, by at least one category or by a combination of at least two or more categories selected from among speed ranges of the mobile body during straight-line travel, driving scenes during travel of the mobile body, or operations for the mobile body.

### [Turning-Travel-Simple-Evaluation Item]

In the present teaching, turning-travel-simple-evaluation item (simple evaluation item for turning travel) refers to a predetermined evaluation item for the driving skill that a driver exhibits during the mobile body's turning travel and wishes to have evaluated. The turning-travel-simple-evaluation item is used to evaluate a predetermined physical quantity included in the travel data of the mobile body during turning travel, based on a predetermined evaluation index, in order to evaluate the driver's driving skill as exhibited during the turning travel. The turning-travel-simple-evaluation items include at least one evaluation item. Turning-travel-simple-evaluation-related information (simple evaluation-related information for turning travel) on the driver's driving skill is assigned to the turning-travel-simple-evaluation item, based on the predetermined evaluation index. The turning-travel-simple-evaluation item may be defined, for example, by at least one category or by a combination of at least two or more categories selected from among speed ranges of the mobile body during turning travel, driving scenes during travel of the mobile body, or operations for the mobile body.

### [Straight-Line-Travel-Simple-Evaluation-Related Information]

In the present teaching, straight-line-travel-simple-evaluation-related information (simple evaluation-related information for straight-line travel) is information that relates to a driver's driving skill and is set for each straight-line-travel-simple-evaluation item based on a predetermined evaluation index. The straight-line-travel-simple-evaluation-related information includes a plurality of comments on the driver's driving skills during straight-line travel, according to the predetermined evaluation indices. For each straight-line-travel-simple-evaluation item, the straight-line-travel-simple-evaluation-related information may include straight-line-travel-simple-evaluation-related information that indicates a high evaluation and straight-line-travel-simple-evaluation-related information that indicates a low evaluation, according to a predetermined evaluation index. The straight-line-travel-simple-evaluation-related information may include information related to a speed range of the mobile body, a driving scene of the mobile body, and an operation of the mobile body.

### [Turning-Travel-Simple-Evaluation-Related Information]

In the present teaching, turning-travel-simple-evaluation-related information (simple evaluation-related information for turning travel) is information that relates to a driver's driving skill and is set for each turning-travel-simple-evaluation item based on a predetermined evaluation index. The turning-travel-simple-evaluation-related information includes a plurality of comments on the driver's driving skills during turning travel, according to the predetermined evaluation indices. For each turning-travel-simple-evaluation item, the turning-travel-simple-evaluation-related information may include turning-travel-simple-evaluation-related information that indicates a high evaluation and turning-travel-simple-evaluation-related information that indicates a low evaluation, according to a predetermined evaluation index. The turning-travel-simple-evaluation-related information may include information related to a speed range of the mobile body, a driving scene of the mobile body, and an operation of the mobile body.

### [Straight-Line-Travel-Detailed-Evaluation Item]

In the present teaching, straight-line-travel-detailed-evaluation item (detailed evaluation item for straight-line travel) refers to an evaluation item classified based on the mobile body's state during straight-line travel, in order to evaluate the driver's driving skill as exhibited during the straight-line travel of the mobile body. The straight-line-travel-detailed-evaluation item is used to evaluate a predetermined physical quantity included in the travel data of the mobile body during straight-line travel, based on a predetermined evaluation index. Straight-line-travel-detailed-evaluation-related information (detailed evaluation-related information for straight-line travel) on the driver's driving skill during straight-line travel of the mobile body is assigned to the straight-line-travel-detailed-evaluation item. The straight-line-travel-detailed-evaluation item may be defined, for example, by at least one category or by a combination of at least two or more categories selected from among speed ranges of the mobile body during straight-line travel, driving scenes during travel of the mobile body, or operations for the mobile body.

### [Turning-Travel-Detailed-Evaluation Item]

In the present teaching, turning-travel-detailed-evaluation item (detailed evaluation item for turning travel) refers to an evaluation item classified based on the mobile body's state during turning travel, in order to evaluate a driver's driving skill as exhibited during the turning travel of the mobile body. The turning-travel-detailed-evaluation item is used to evaluate a predetermined physical quantity included in the travel data of the mobile body during turning travel, based on a predetermined evaluation index. Turning-travel-detailed-evaluation-related information (detailed evaluation-related information for turning travel) on the driver's driving skill during turning travel of the mobile body is assigned to the turning-travel-detailed-evaluation item. The turning-travel-detailed-evaluation item may be defined, for example, by at least one category or by a combination of at least two or more categories selected from among speed ranges of the mobile body during turning travel, driving scenes during travel of the mobile body, or operations for the mobile body.

### [Straight-Line-Travel-Detailed-Evaluation-Related Information]

In the present teaching, straight-line-travel-detailed-evaluation-related information (detailed evaluation-related information for straight-line travel) is information that relates to a driver's driving skill and is set for each straight-line-travel-detailed-evaluation item based on a predetermined evaluation index. The straight-line-travel-detailed-evaluation-related information includes a plurality of comments on the driver's driving skills during straight-line travel. The straight-line-travel-detailed-evaluation-related information may include information related to a speed range of the mobile body, a driving scene of the mobile body, and an operation of the mobile body. For each straight-line-travel-detailed-evaluation item, the straight-line-travel-detailed-evaluation-related information may include straight-line-travel-detailed-evaluation-related information that indicates a high evaluation and straight-line-travel-detailed-evaluation-related information that indicates a low evaluation, according to the predetermined evaluation index.

### [Turning-Travel-Detailed-Evaluation-Related Information]

In the present teaching, turning-travel-detailed-evaluation-related information (detailed evaluation-related information for turning travel) is information that relates to a driver's driving skill and is set for each turning-travel-detailed-evaluation item based on a predetermined evaluation index. The turning-travel-detailed-evaluation-related information includes a plurality of comments on the driver's driving skills during turning travel. The turning-travel-detailed-evaluation-related information may include information related to a speed range of the mobile body, a driving scene of the mobile body, and an operation of the mobile body. For each turning-travel-detailed-evaluation item, the turning-travel-detailed-evaluation-related information may include turning-travel-detailed-evaluation-related information that indicates a high evaluation and turning-travel-detailed-evaluation-related information that indicates a low evaluation, according to the predetermined evaluation index.

### [Predetermined Evaluation Index]

In the present teaching, a predetermined evaluation index refers to a magnitude of a physical quantity, a frequency of occurrence, an amount of positional deviation, a range of variation, a magnitude of an average value, a magnitude of change, and the like, which serve as evaluation axes for evaluating a predetermined physical quantity in the straight-line-travel-simple-evaluation item, the turning-travel-simple-evaluation item, the straight-line-travel-detailed-evaluation item, and the turning-travel-detailed-evaluation item. The determination of whether an evaluation result of each evaluation item is high or low is based on a predetermined evaluation index. For example, the evaluation indices for the body sway of a vehicle include a magnitude of angular velocity in the left-right direction, an amount of change in angular velocity, and a frequency occurrence of angular velocity.

### [Predetermined Condition]

In the present teaching, a predetermined condition refers to a condition for selecting a simple evaluation item or a detailed evaluation item for which simple-evaluation-related information or detailed-evaluation-related information is displayed, from among simple evaluation items or detained evaluation items. The predetermined condition includes selection conditions, such as the ranking of evaluation results of a plurality of simple evaluation items or a plurality of detailed evaluation items evaluated according to predetermined evaluation indices, values or reference values of those evaluation results, and a category of each evaluation item. For example, for a plurality of straight-line-travel-detailed-evaluation items and a plurality of turning-travel-detailed-evaluation items, the predetermined condition is defined as the highest and lowest evaluations according to predetermined evaluation indices.

### [One Driving Cycle]

One driving cycle herein refers to a period of travel of the mobile body that starts when a posture, and a speed in the front-rear direction, of the mobile body change from a predetermined state and ends when they return to the predetermined state again. The posture of the mobile body may be defined based on the direction of gravity. In other words, the posture of the mobile body is determined by how the up-down, left-right, and front-rear directions of the mobile body are oriented with respect to the direction of gravity. The one driving cycle may refer to, for example, a period of travel of the mobile body that starts when the mobile body starts moving from a stopped state and ends when it comes to a stop again. The posture of the mobile body at both the beginning and the end of the one driving cycle may be upright or leaning. The speed of the mobile body at both the beginning and the end of the one driving cycle may be zero or nonzero.

### [One Driving Cycle When the Mobile Body Is a Leaning Vehicle]

In this specification, when the mobile body is a leaning vehicle, the beginning of the one driving cycle, the end of the one driving cycle, and one or more acceleration/deceleration sections during a period between the beginning and the end of the one driving cycle, may include left and right turns at intersections, cornering on curves, and the like, or may be free of them. The one driving cycle may include a state in which the leaning vehicle is stopped or moving at an extremely low speed. For example, the one driving cycle may be a period that starts when the leaning vehicle is initially stopped in an upright state with respect to the ground and ends when it eventually returns to a stopped, upright state with respect to the ground again. The stopped state of the leaning vehicle includes not only an upright state of the leaning vehicle, but also a parked state in which the leaning vehicle is supported by a center stand or side stand, and a leaning state in which the leaning vehicle stops with the driver resting one foot on the ground, such as when waiting at a traffic light.

### Advantageous Effects of Invention

According to one embodiment of the present teaching, it is possible to provide a travel-data-processing device, a travel-data-measurement device, and a travel-data-measurement-processing device configured to output comments for encouraging improvement in a driver's driving skills of a mobile body, wherein the decrease in design flexibility of hardware resources, such as processors and memory, can be suppressed.

### BRIEF DESCRIPTION OF DRAWINGS

FIG. 1 is a view showing a schematic configuration of a travel-data-processing device according to a first embodiment of the present teaching.

FIG. 2 is a block diagram showing a schematic configuration of a travel data processor provided in the travel-data-processing device shown in FIG. 1.

FIG. 3 is a schematic view showing the process by which a data segmenting section shown in FIG. 2 segments travel data into straight-line-travel data and turning travel data.

FIG. 4 is a view illustrating screens displayed by an output section shown in FIG. 2.

FIG. 5 is a flow chart showing the display control of simple-evaluation-related information and detailed-evaluation-related information by the travel-data-processing device.

FIG. 6 is a schematic view showing an example of straight-line-travel-detailed-evaluation item and turning-travel-detailed-evaluation item.

FIG. 7 is an illustration of straight-line-travel-detailed-evaluation-related information and turning-travel-detailed-evaluation-related information for the example of the straight-line-travel-detailed-evaluation item and the turning-travel-detailed-evaluation item shown in FIG. 6.

FIG. 8 is a schematic view showing a configuration in which the travel-data-processing device and a travel-data-measurement device are built into a mobile terminal.

FIG. 9 is a schematic view showing a configuration of a travel-data-measurement-processing device in which a travel data processor and a travel-data-measurement processor are configured as a single processor.

FIG. 10 is a schematic view showing a configuration in which a travel-data-processing device and a travel-data-measurement device are electrically connected by communication devices.

### DESCRIPTION OF EMBODIMENT

Embodiments will be described hereinafter with reference to the drawings. The dimensions of components in the drawings do not strictly represent actual dimensions of the components, dimensional proportions of the components, and the like.

### First Embodiment

### (Travel-Data-Processing Device)

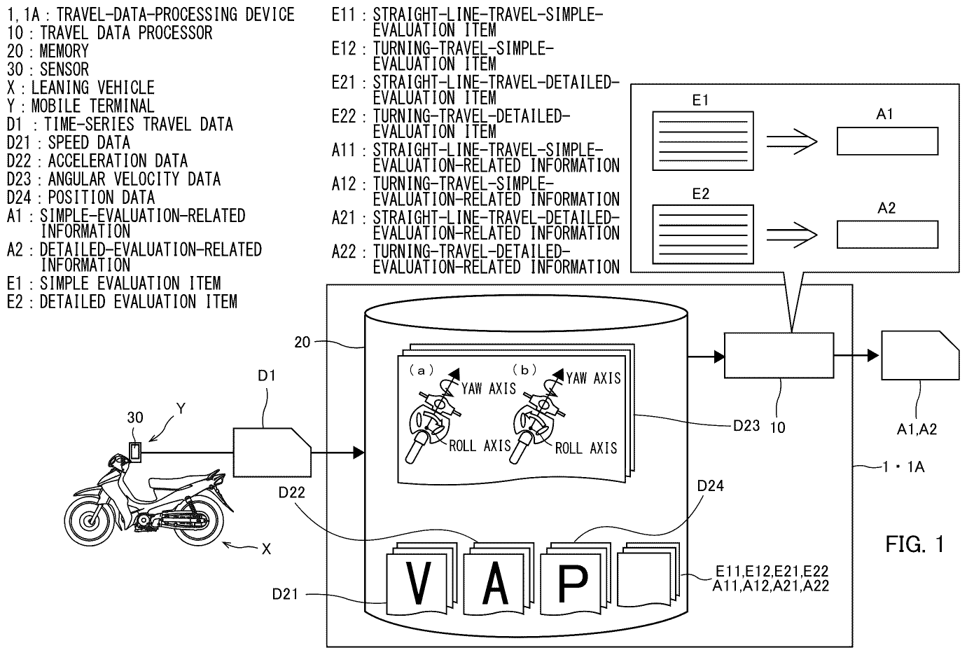

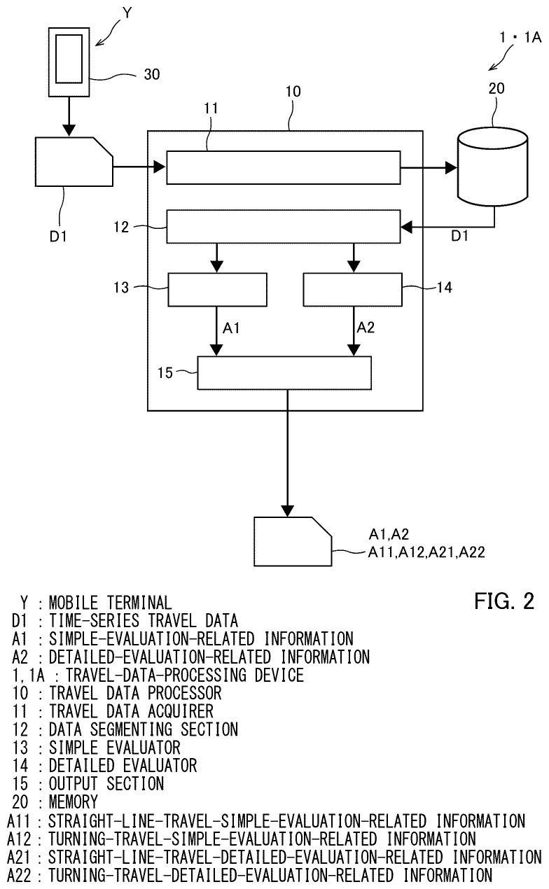

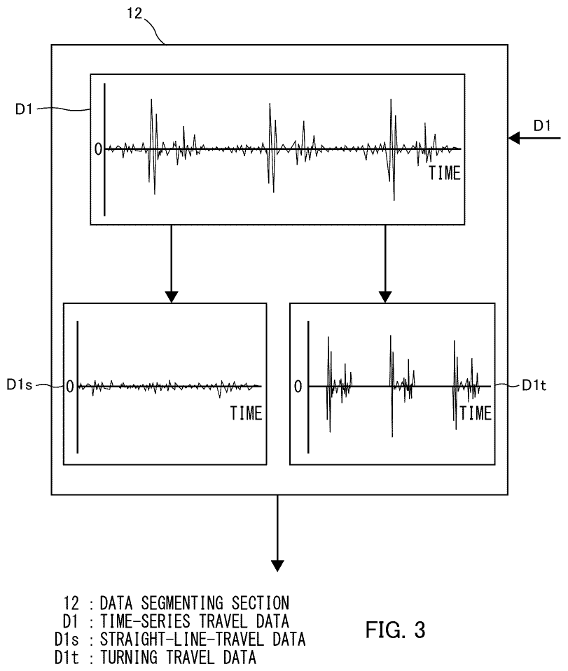

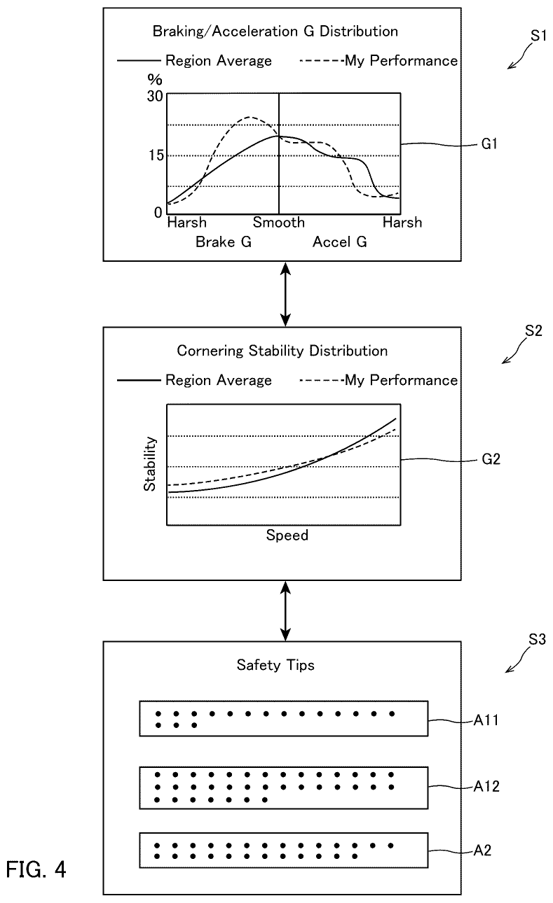

With reference to FIGS. 1 to 4, a travel-data-processing device 1 according to a first embodiment of the present teaching will be described. FIG. 1 is a view showing a schematic configuration of the travel-data-processing device 1 according to the first embodiment of the present teaching. FIG. 2 is a block diagram showing a schematic configuration of a travel data processor 10 provided in the travel-data-processing device 1 shown in FIG. 1. FIG. 3 is a schematic view showing the process by which a data segmenting section 12 shown in FIG. 2 segments travel data into straight-line-travel data DIs and turning travel data D1t. FIG. 4 is a view illustrating screens S1, S2, and S3 displayed by an output section 15 shown in FIG. 2.

As shown in FIGS. 1 and 2, the travel-data-processing device 1 evaluates a driver's driving skill based on travel data of a leaning vehicle X. The travel-data-processing device 1 has a travel data processor (processor for processing travel data) 10 and a memory 20.

The travel-data-processing device 1 may be a mobile terminal Y owned by the driver of the leaning vehicle X. Alternatively, the travel-data-processing device 1 may be an arithmetic processing unit that acquires data output by a sensor 30 incorporated into the mobile terminal Y via a communication device and performs computational processing. The travel-data-processing device 1 is a device that outputs travel data in the coordinate system of the leaning vehicle X, based on the output of the sensor 30 built into the mobile terminal Y.

The sensor 30, serving as a detection device for detecting a physical quantity related to a behavior of the leaning vehicle X, includes, for example, an inertial measurement unit (IMU) having an acceleration sensor and an angular velocity sensor. The sensor 30 may be a sensor other than an IMU, as long as it is capable of detecting at least speed of the leaning vehicle X, acceleration along three coordinate axes in the coordinate system of the sensor 30, and angular velocity about the three coordinate axes in the coordinate system of the sensor 30. The sensor 30 may be configured as a combination of the IMU and other sensors.

The sensor 30 includes a GPS (Global Positioning System) incorporated into the mobile terminal Y. The sensor 30 is capable of outputting the speed of the leaning vehicle X based on GPS positioning data. In addition, the sensor 30 may include a speed sensor capable of outputting speed without relying on GPS positioning data. The sensor 30 may be configured as a combination of a GPS sensor and other sensors. The sensor 30 may be configured as a combination of the speed sensor and other sensors.

The sensor 30 may be configured as a combination of a sensor capable of detecting one or more types of physical quantities among the leaning vehicle X's speed, acceleration along the three coordinate axes, and angular velocity about the three coordinate axes, and one or more sensors capable of detecting the remaining types of the physical quantities. The sensor 30 may be capable of detecting at least one of the acceleration along the three axes, the angle about the three axes, or the angular acceleration about the three axes.

The mobile terminal Y is attached to a handlebar of the leaning vehicle X. There are no particular restrictions on who attaches the mobile terminal Y to the leaning vehicle X, and the installer may be the driver of the leaning vehicle X or a technician who performs maintenance on the leaning vehicle X.

The sensor 30 that is built into the mobile terminal Y attached to the handlebar of the leaning vehicle X in this manner detects data on a physical quantity related to a behavior of the leaning vehicle X in the coordinate system with respect to the sensor 30, and outputs it as travel data. In this embodiment, the coordinate system with respect to the sensor 30 is assumed to coincide with the coordinate system with respect to the leaning vehicle X. In other words, the detected data by the sensor 30 is data in the coordinate system with respect to the leaning vehicle X.

The travel data output by the sensor 30 includes physical quantities, such as the speed along the three axes, i.e., in the front-rear direction, the up-down direction, and the left-right direction, in the coordinate system of the sensor 30, the acceleration and jerk along the three coordinate axes in the coordinate system of the sensor 30, the angle, angular velocity, and angular acceleration about the three coordinate axes (roll axis, yaw axis, pitch axis) in the coordinate system of the sensor 30. The sensor 30 outputs the travel data to the travel-data-processing device 1 in a time-series manner.

Here, one driving cycle is defined as a period starting from a predetermined state in which the leaning vehicle X is upright with respect to the ground and has zero speed in the front-rear direction, and eventually returning to that same predetermined state in which the leaning vehicle X is upright with respect to the ground and has zero speed in the front-rear direction after the leaning vehicle X has accelerated or decelerated one or more times.

The sensor 30 outputs travel data for at least one driving cycle to the travel-data-processing device 1 in a time-series manner. Hereinafter, the travel data output in the time-series manner by the sensor 30 is referred to as “time-series travel data”.

The memory 20 may be a memory capable of temporary storage, or it may be a non-volatile read/write storage medium, such as flash memory or a hard disk. The memory 20 may have any configuration, as long as it is capable of temporarily or permanently storing the data acquired or subjected to computational processing by the travel data processor 10.

The memory 20 stores time-series travel data D1 for at least one driving cycle, which is output from the sensor 30 built into the mobile terminal Y attached to the handlebar of the leaning vehicle X. In this embodiment, the time-series travel data D1 for one driving cycle of the leaning vehicle X includes straight-line-travel data D1s during straight-line travel and turning travel data D1t during turning travel.

In FIG. 1, the time-series travel data D1 of the leaning vehicle X stored in the memory 20 includes speed data D21, acceleration data D22, angular velocity data D23, and position data D24 detected by GPS.

The speed data D21 is related to the speed of the leaning vehicle X while it is traveling. The speed data D21 includes the speed calculated based on a change in position detected by the GPS incorporated into the mobile terminal Y. The speed data D21 includes position data.

The acceleration data D22 includes data related to the acceleration along the three coordinate axes in the coordinate system of the sensor 30, as detected by the sensor 30 while the leaning vehicle X is traveling.

The angular velocity data D23 includes data related to the angular velocity when the vehicle body is caused to lean to the left or right from an upright state or caused to return to an upright state from a leftward or rightward lean while the leaning vehicle X is traveling.

The position data D24 includes data related to the position indicated by the three coordinate axes of the leaning vehicle X as detected by the GPS while the leaning vehicle X is traveling, and the posture of the leaning vehicle X, including a head angle of the leaning vehicle X.

The memory 20 stores a predetermined straight-line-travel-simple-evaluation item (simple evaluation item for straight-line travel) E11 and a predetermined turning-travel-simple-evaluation item (simple evaluation item for turning travel) E12 as predetermined simple evaluation items E1 for evaluating evaluation items for the driving skills that the driver wishes to have evaluated, as well as a straight-line-travel-detailed-evaluation item (detailed evaluation item for straight-line travel) E21 and a turning-travel-detailed-evaluation item (detailed evaluation item for turning travel) E22 as detailed evaluation items E2 for evaluating the driver's driving skills from multiple perspectives.

The straight-line-travel-simple-evaluation item E11 stored in the memory 20 is a predetermined evaluation item for evaluating a predetermined physical quantity included in the time-series travel data D1 of the leaning vehicle X during straight-line travel, based on a predetermined evaluation index, in order to perform a simple evaluation of a driving skill that the driver exhibits during the straight-line travel of the leaning vehicle X and wishes to have evaluated. For example, the straight-line-travel-simple-evaluation item E11 may be an evaluation item for the driver's important driving skill in straight-line travel, such as acceleration and deceleration operations during straight-line travel of the leaning vehicle X.

The turning-travel-simple-evaluation item E12 stored in the memory 20 is a predetermined evaluation item for evaluating a predetermined physical quantity included in the time-series travel data D1 of the leaning vehicle X during turning travel, based on a predetermined evaluation index, in order to perform a simple evaluation of a driving skill that the driver exhibits during the turning travel of the leaning vehicle X and wishes to have evaluated. For example, the turning-travel-simple-evaluation item E12 may be an evaluation item for the driver's important driving skill in turning travel, such as swaying during turning travel of the leaning vehicle X.

A plurality of straight-line-travel-detailed-evaluation items E21 stored in the memory 20 are evaluation items for evaluating predetermined physical quantities included in the time-series travel data D1 of the leaning vehicle X during straight-line travel, based on predetermined evaluation indices, in order to perform a detailed evaluation of the driver's driving skills as exhibited during the straight-line travel of the leaning vehicle X. For example, the straight-line-travel-detailed-evaluation items E21 may include an evaluation item that is defined by at least one requirement or by a combination of at least two or more requirements that indicate the travel state of the leaning vehicle X, such as speed ranges of the leaning vehicle X, driving scenes during travel of the leaning vehicle X, or operations of the leaning vehicle X.

A plurality of turning-travel-detailed-evaluation items E22 stored in the memory 20 are evaluation items for evaluating predetermined physical quantities included in the time-series travel data D1 of the leaning vehicle X during turning travel, based on predetermined evaluation indices, in order to perform a detailed evaluation of the driver's driving skills as exhibited during the turning travel of the leaning vehicle X. For example, the turning-travel-detailed-evaluation items E22 may include an evaluation item that is defined by at least one requirement or by a combination of at least two or more requirements that indicate the travel state of the leaning vehicle X, such as speed ranges of the leaning vehicle X, driving scenes during travel of the leaning vehicle X, or operations of the leaning vehicle X.

The memory 20 stores straight-line-travel-simple-evaluation-related information (simple evaluation-related information for straight-line travel) A11 for the straight-line-travel-simple-evaluation item E11 and turning-travel-simple-evaluation-related information (simple evaluation-related information for turning travel) A12 for the turning-travel-simple-evaluation item E12, as well as straight-line-travel-detailed-evaluation-related information (detailed evaluation-related information for straight-line travel) A21 for the straight-line-travel-detailed-evaluation item E21 and turning-travel-detailed-evaluation-related information (detailed evaluation-related information for turning travel) A22 for the turning-travel-detailed-evaluation item E22 as detailed-evaluation-related information A2.

The straight-line-travel-simple-evaluation-related information A11 included in the simple-evaluation-related information A1 stored in the memory 20 is information that relates to an evaluation of the driver's driving skill and is set for the straight-line-travel-simple-evaluation item E11. The straight-line-travel-simple-evaluation-related information A11 includes comments on an evaluation result of a driving skill that the driver exhibits during straight-line travel of the leaning vehicle X and wishes to have evaluated, for example, comments on its strengths or areas for improvement.

The turning-travel-simple-evaluation-related information A12 included in the simple-evaluation-related information A1 stored in the memory 20 is information that relates to an evaluation of the driver's driving skill and is set for the turning-travel-simple-evaluation item E12. The turning-travel-simple-evaluation-related information A12 includes comments on an evaluation result of a driving skill that the driver exhibits during turning travel of the leaning vehicle X and wishes to have evaluated, for example, comments on its strengths or areas for improvement.

The straight-line-travel-detailed-evaluation-related information A21 included in the detailed-evaluation-related information A2 stored in the memory 20 is information that relates to an evaluation of the driver's driving skill and is set for each of the plurality of straight-line-travel-detailed-evaluation items E21. The straight-line-travel-detailed-evaluation-related information A21 includes comments on the evaluation of the driver's driving skill during straight-line travel. The straight-line-travel-detailed-evaluation-related information A21 for each corresponding evaluation item may include information related to an evaluation of a driving skill based on a speed range of the leaning vehicle X, a driving scene of the leaning vehicle X, and an operation of the leaning vehicle X. The straight-line-travel-detailed-evaluation-related information A21 for each straight-line-travel-detailed-evaluation item E21 may include straight-line-travel-detailed-evaluation-related information A21H that indicates a high evaluation and straight-line-travel-detailed-evaluation-related information A21L that indicates a low evaluation, according to a predetermined evaluation index.

The turning-travel-detailed-evaluation-related information A22 included in the detailed-evaluation-related information A2 stored in the memory 20 is information that relates to an evaluation of the driver's driving skill and is set for each of the plurality of turning-travel-detailed-evaluation items E22. The turning-travel-detailed-evaluation-related information A22 includes comments on the evaluation of the driver's driving skill during turning travel. In this embodiment, the turning-travel-detailed-evaluation-related information A22 may include information related to an evaluation of a driving skill based on a speed range of the leaning vehicle X, a driving scene of the leaning vehicle X, and an operation of the leaning vehicle X that are included in each corresponding turning-travel-detailed-evaluation item E22. The turning-travel-detailed-evaluation-related information A22 for each turning-travel-detailed-evaluation item E22 may include turning-travel-detailed-evaluation-related information A22H that indicates a high evaluation and turning-travel-detailed-evaluation-related information A22L that indicates a low evaluation, according to a predetermined evaluation index.

The data stored in the memory 20 are not limited to this, and the memory 20 may store data other than the speed data D21, the acceleration data D22, the angular velocity data D23, the straight-line-travel-simple-evaluation item E11, the turning-travel-simple-evaluation item E12, the straight-line-travel-detailed-evaluation item E21, the turning-travel-detailed-evaluation item E22, the straight-line-travel-simple-evaluation-related information A11, the turning-travel-simple-evaluation-related information A12, the straight-line-travel-detailed-evaluation-related information A21, and the turning-travel-detailed-evaluation-related information A22.

As shown in FIG. 2, the travel data processor 10 is a central processing unit used in computers, for example. The travel data processor 10 has a travel data acquirer 11, a data segmenting section 12, a simple evaluator 13, a detailed evaluator 14, and an output section 15. The travel data processor 10 is electrically connected to the memory 20.

Although not specifically shown in the figure, the travel data processor 10 acquires the time-series travel data D1 for at least one driving cycle output from the sensor 30, and stores the acquired time-series travel data D1 in the memory 20. In addition, after acquiring the time-series travel data D1 for at least one driving cycle, the travel data processor 10 performs computational processing using the data on a physical quantity related to straight-line travel of the mobile body extracted from the time-series travel data D1 stored in the memory 20, and can thereby output externally the straight-line-travel-simple-evaluation-related information A11, the turning-travel-simple-evaluation-related information A12, and the detailed evaluation-related information A2 including at least one of the straight-line-travel-detailed-evaluation-related information A21 or the turning-travel-detailed-evaluation-related information A22 (see FIG. 1).

In this manner, the travel-data-processing device 1 can output the simple-evaluation-related information A1 and the detailed-evaluation-related information A2 on the driver's driving skills as exhibited during straight-line travel and turning travel, based on the time-series travel data D1 for at least one driving cycle.

For example, the travel data processor 10 may be configured such that only the portion having a function of acquiring the time-series travel data D1 for at least one driving cycle that is output from the sensor 30 is separated from the central processing unit of the main body and provided as a measurement processor in the mobile terminal Y.

The travel data acquirer 11 acquires the time-series travel data D1 output from the sensor 30 attached to the leaning vehicle X and stores it in the memory 20. The travel data acquirer 11 acquires the speed data D21, the acceleration data D22, and the angular velocity data D23, of the leaning vehicle X, included in the time-series travel data D1 and stores them in the memory 20.

The travel data acquirer 11 may acquire data other than the speed data D21, the acceleration data D22, and the angular velocity data D23 included in the time-series travel data D1. For example, the travel data acquirer 11 may acquire, from the sensor 30, a physical quantity related to the behavior of the leaning vehicle X other than the speed data D21, the acceleration data D22, and the angular velocity data D23, as the time-series travel data D1, and store them in the memory 20. Specifically, the travel data acquirer 11 may acquire, from the sensor 30, at least one of acceleration along the three axes, angle about the three axes, or angular acceleration about the three axes from the time-series travel data D1, and store it in the memory 20.

As shown in FIGS. 2 and 3, the data segmenting section 12 segments the time-series travel data D1 for at least one driving cycle in the coordinate system of the sensor 30, stored in the memory 20, into the straight-line-travel data D1s during straight-line travel of the leaning vehicle X and the turning travel data D1t during turning travel of the leaning vehicle X. For example, the data segmenting section 12 calculates the turning travel data D1t from the time-series travel data D1, based on the angular velocity data D23 included in the time-series travel data D1, the time period during which the angular velocity data D23 is generated, and physical quantities generated during turning travel, such as a head angle of the leaning vehicle X. Furthermore, the data segmenting section 12 calculates the straight-line-travel data D1s as the portion of the time-series travel data D1 excluding the turning travel data D1t calculated in the time-series travel data D1. In this manner, the data segmenting section 12 segments the time-series travel data D1 into the straight-line-travel data D1s and the turning travel data D1t.

As shown in FIG. 2, based on the time-series travel data D1 for at least one driving cycle in the coordinate system of the sensor 30, which is stored in the memory 20, the simple evaluator 13 generates the simple-evaluation-related information A1 on the driver's driving skill.

The simple evaluator 13 evaluates a predetermined physical quantity included in the straight-line-travel data D1s based on a predetermined evaluation index, for a predetermined straight-line-travel-simple-evaluation item E11 (see FIG. 1) that the driver wishes to have evaluated. Furthermore, the simple evaluator 13 selects straight-line-travel-simple-evaluation-related information A11 corresponding to an evaluation result of the straight-line travel-simple-evaluation item E11, from among a plurality of pieces of straight-line-travel-simple-evaluation-related information A11 stored in the memory 20. The simple evaluator 13 outputs the selected straight-line-travel-simple-evaluation-related information A11 to the output section 15.

The simple evaluator 13 evaluates a predetermined physical quantity included in the turning-travel data D1t based on a predetermined evaluation index, for a predetermined turning-travel-simple-evaluation item E12 (see FIG. 1) that the driver wishes to have evaluated. Furthermore, the simple evaluator 13 selects turning-travel-simple-evaluation-related information A12 corresponding to an evaluation result of the turning-travel-simple-evaluation item E12, from among a plurality of pieces of turning-travel-simple-evaluation-related information A12 stored in the memory 20. The simple evaluator 13 outputs the selected turning-travel-simple-evaluation-related information A12 to the output section 15.

Based on the time-series travel data D1 for at least one driving cycle in the coordinate system of the sensor 30, which is stored in the memory 20, the detailed evaluator 14 generates the detailed-evaluation-related information A2 on the driver's driving skill.

The detailed evaluator 14 evaluates a predetermined physical quantity included in the straight-line-travel data D1s based on a predetermined evaluation index, for each of the plurality of straight-line-travel-detailed-evaluation items E21 (see FIG. 1). In other words, the detailed evaluator 14 evaluates a driving skill of the driver for each of the plurality of straight-line-travel-detailed-evaluation items E21. Furthermore, the detailed evaluator 14 evaluates a predetermined physical quantity included in the turning travel data D1t based on a predetermined evaluation index, for each of the plurality of turning-travel-detailed-evaluation items E22 (see FIG. 1). In other words, the detailed evaluator 14 evaluates a driving skill of the driver for each of the plurality of turning-travel-detailed-evaluation items E22.

Next, the detailed evaluator 14 selects a detailed evaluation item E2 as an item for which an evaluation result satisfying a predetermined condition has been obtained, from among the plurality of straight-line-travel-detailed-evaluation items E21 and the plurality of turning-travel-detailed-evaluation items E22. The detailed evaluator 14 outputs to the output section 15, detailed-evaluation-related information A2 corresponding to the evaluation result of the detailed evaluation item E2, selected from among the plurality of pieces of straight-line-travel-detailed-evaluation-related information A21 and the plurality of pieces of turning-travel-detailed-evaluation-related information A22 stored in the memory 20.

As shown in FIGS. 2 to 4, the output section 15 is, for example, a display device and a communication device of the mobile terminal Y. The output section 15 outputs externally or displays on the display screen, the straight-line-travel-simple-evaluation-related information A11 and the turning-travel-simple-evaluation-related information A12 selected by the simple evaluator 13 as well as the detailed-evaluation-related information A2 selected by the detailed evaluator 14, as data. The output section 15 may display the time-series travel data D1, a graph G1 related to a predetermined physical quantity included in the straight-line-travel data D1s, and a graph G2 related to a predetermined physical quantity included in the turning travel data D1t. The output section 15 may also display information, such as the current position of the leaning vehicle X, a map showing, for example, the travel route taken by the leaning vehicle X, and the speed and travel distance of the leaning vehicle X.

The output section 15 is capable of displaying the time-series travel data D1, the straight-line-travel data D1s, the turning travel data D1t, the straight-line-travel-simple-evaluation-related information A11, the turning-travel-simple-evaluation-related information A12, and the detailed evaluation-related information A2 by switching the display screens. For example, the output section 15 is configured to be switchable between a screen S1 for displaying information related to the predetermined physical quantity included in the straight-line-travel data D1s, a screen S2 for displaying information related to the predetermined physical quantity that is included in the turning travel data D1t and used for evaluation of the turning-travel-simple-evaluation item E12, and a screen S3 for displaying the straight-line-travel-simple-evaluation-related information A11, the turning-travel-simple-evaluation-related information A12, and the detailed-evaluation-related information A2.

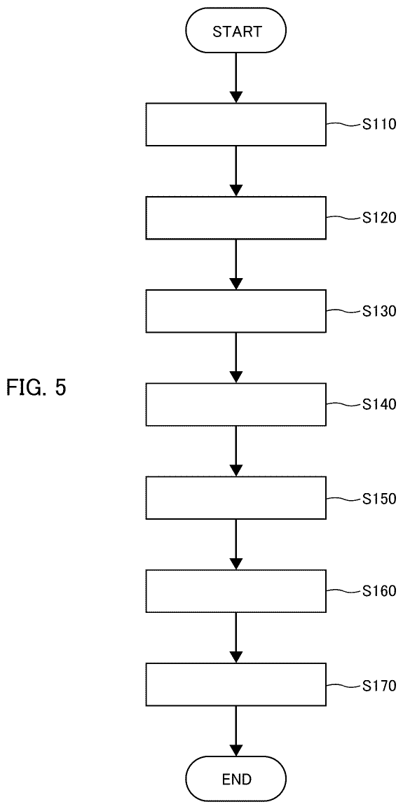

Next, with reference to using FIG. 5, the display control of the simple-evaluation-related information A1 and the detailed-evaluation-related information A2 by the travel-data-processing device 1 will be described.

As shown in FIG. 5, in step S110, the travel data processor 10 acquires time-series travel data D1 from the sensor 30. The travel data processor 10 moves to step S120.

In step S120, the travel data processor 10 segments the acquired time-series travel data D1 into straight-line-travel data D1s and turning travel data D1t. The travel data processor 10 moves to step S130.

In step S130, the travel data processor 10 evaluates a predetermined physical quantity included in the straight-line-travel data D1s based on a predetermined evaluation index, for a straight-line-travel-simple-evaluation item E11. Similarly, the travel data processor 10 evaluates a predetermined physical quantity included in the turning travel data D1t based on a predetermined evaluation index, for a turning-travel-simple-evaluation item E12. The travel data processor 10 moves to step S140.

In step S140, the travel data processor 10 evaluates a predetermined physical quantity included in the straight-line-travel data D1s based on a predetermined evaluation index, for each of a plurality of straight-line-travel-detailed-evaluation items E21. Similarly, the travel data processor 10 evaluates a predetermined physical quantity included in the turning travel data D1t based on a predetermined evaluation index, for each of a plurality of turning-travel-detailed-evaluation items E22. The travel data processor 10 moves to step S150.

In step S150, the travel data processor 10 selects straight-line-travel-simple-evaluation-related information A11 stored in the memory 20, based on an evaluation result of the straight-line-travel-simple-evaluation item E11. Similarly, the travel data processor 10 selects turning-travel-simple-evaluation-related information A12 stored in the memory 20, based on an evaluation result of the turning-travel-simple-evaluation item E12. The travel data processor 10 moves to step S160.

In step S160, the travel data processor 10 selects a detailed evaluation item E2 with an evaluation result that satisfies a predetermined condition, from among evaluation results of the plurality of straight-line-travel-detailed-evaluation items E21 and the plurality of turning-travel-detailed-evaluation items E22. The travel data processor 10 proceeds to step S170.

In step S170, the travel data processor 10 outputs the selected straight-line-travel-simple-evaluation-related information A11 and turning-travel-simple-evaluation-related information A12 to the output section 15. Similarly, the travel data processor 10 outputs detailed-evaluation-related information A2 corresponding to the selected detailed evaluation item E2 to the output section 15.

The travel-data-processing device 1, configured as described above, evaluates evaluation items for the driving skills that the driver of the leaning vehicle X exhibits during straight-line travel and turning travel and wishes to have evaluated, by using the straight-line-travel-simple-evaluation item E11 and the turning-travel-simple-evaluation item E12. The travel data processing device 1 also evaluates the driver's driving skills as exhibited in various travel states of the leaning vehicle X, by using the plurality of straight-line-travel-detailed-evaluation items E21 and the plurality of turning-travel-detailed-evaluation items E22. Furthermore, the travel-data-processing device 1 selects a detailed-evaluation item E2 satisfying a predetermined condition, from among the plurality of straight-line-travel-detailed-evaluation items E21 and the plurality of turning-travel-detailed-evaluation items E22, and outputs the corresponding detailed-evaluation-related information A2. In this manner, by incorporating the evaluation items that the driver wishes to have evaluated, the detailed-evaluation-related information A2 on the driving skills to encourage improvement in the driver's driving skills can be output from multiple perspectives.

In addition, the travel-data-processing device 1 outputs the detailed-evaluation-related information A2 regarding the evaluation result of the selected detailed evaluation item E2, thereby reducing the amount of data processed by the travel data processor 10.

This enables a configuration that outputs the simple-evaluation-related information A1 and the detailed-evaluation-related information A2 for encouraging improvement in the driving skills of the driver of the leaning vehicle X, wherein the decrease in design flexibility of hardware resources, such as the travel data processor 10 and the memory 20, can be suppressed.

### Second Embodiment

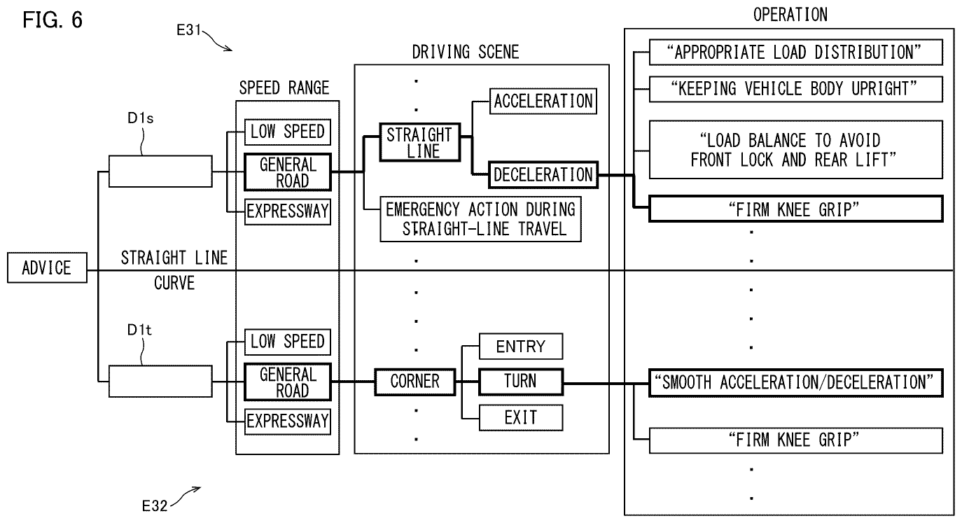

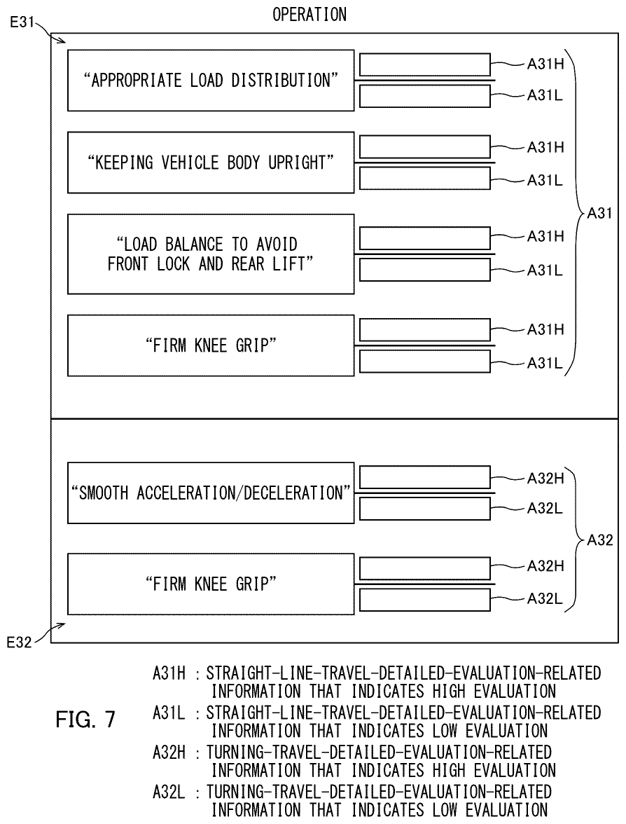

With reference to FIGS. 1, 2, and 6 to 7, a travel-data-processing device 1A according to a second embodiment of the present teaching will be described. FIG. 6 is a schematic view showing an example of straight-line-travel-detailed-evaluation item (detailed evaluation item for straight-line travel) E31 and turning-travel-detailed-evaluation item (detailed evaluation item for turning travel) E32. FIG. 7 is an illustration of straight-line-travel-detailed-evaluation-related information (detailed evaluation-related information for straight-line travel) A31 and turning-travel-detailed-evaluation-related information (detailed evaluation-related information for turning travel) A32, for the example of the straight-line-travel-detailed-evaluation item E31 and the turning-travel-detailed-evaluation item E32 shown in FIG. 6.

As shown in FIGS. 1 and 2, the travel-data-processing device 1A of the second embodiment differs from the travel-data-processing device 1 of the first embodiment in that it outputs detailed-evaluation-related information A2 that indicates a high evaluation according to a predetermined evaluation index and detailed-evaluation-related information A2 that indicates a low evaluation according to a predetermined evaluation index, for the detailed evaluation items E3. In this embodiment, the travel-data-processing device 1A outputs the detailed-evaluation-related information A2 that indicates a high evaluation according to a predetermined evaluation index or the detailed-evaluation-related information A2 that indicates a low evaluation according to a predetermined evaluation index, for a detailed evaluation item E3. In the following description of the embodiment, components common to those of the travel-data-processing device 1 according to the first embodiment are designated with the same reference numerals and their detailed descriptions are not repeated.

### (Simple Evaluation Item)

The straight-line-travel-simple-evaluation item E11 that is a simple evaluation item E1, and the straight-line-travel-simple-evaluation-related information A11 will be described. The simple evaluation item E1 is an item for which an evaluation result is displayed regardless of the result of evaluation of a driving skill. In other words, the simple evaluation item E1 is an item for which an evaluation result is always displayed. The simple evaluation item E1 may be configured such that it is changeable to any arbitrary item.

As shown in FIGS. 1 and 2, the straight-line-travel-simple-evaluation item E11 as the simple evaluation item E1 is, for example, an evaluation item for acceleration and deceleration operations of the driver during straight-line travel of the leaning vehicle X. The straight-line-travel-simple-evaluation item E11 is evaluated based on acceleration and deceleration in the front-rear direction that are predetermined physical quantities included in the straight-line-travel data D1s. The straight-line-travel-simple-evaluation item Ellis an evaluation item that is evaluated when a predetermined physical quantity is included in the straight-line-travel data D1s.

The turning-travel-simple-evaluation item E12 as the simple evaluation item E1 is, for example, an evaluation item for the body sway of the leaning vehicle X caused by the driver during turning travel. The turning-travel-simple-evaluation item E12 is evaluated based on angular velocity in the left-right direction that is a predetermined physical quantity included in the turning travel data D1t. The turning-travel-simple-evaluation item E12 is an evaluation item that is evaluated when a predetermined physical quantity is included in the turning travel data D1t.

The straight-line-travel-simple-evaluation-related information A11 is, for example, information related to acceleration and deceleration operations by the driver during straight-line travel, as evaluated in the straight-line-travel-simple-evaluation item E11. For example, the straight-line-travel-simple-evaluation-related information A11 includes at least two of information related to a speed range of the leaning vehicle X, information related to a driving scene of the leaning vehicle X, or information related to an operation of the leaning vehicle X. In other words, the straight-line-travel-simple-evaluation-related information A11 includes information corresponding to evaluation contents of its corresponding straight-line-travel-simple-evaluation item E11.

The turning-travel-simple-evaluation-related information A12 is, for example, information related to the body sway of the vehicle caused by the driver during turning travel, as evaluated in the turning-travel-simple-evaluation item E12. For example, the turning-travel-simple-evaluation-related information A12 includes at least two of information related to a speed range of the leaning vehicle X, information related to a driving scene of the leaning vehicle X, or information related to an operation of the leaning vehicle X. In other words, the turning-travel-simple-evaluation-related information A12 includes information corresponding to evaluation contents of its corresponding turning-travel-simple-evaluation item E12.

As shown in FIG. 6, straight-line-travel-detailed-evaluation item E31 is an evaluation item for evaluating a predetermined physical quantity measured during straight-line travel and included in the time-series travel data D1 of the leaning vehicle X, based on a predetermined evaluation index, in order to evaluate the driver's driving skill as exhibited during the straight-line travel of the leaning vehicle X. The straight-line-travel-detailed-evaluation item E31 is stored in the memory 20 (see FIG. 2).

The straight-line-travel-detailed-evaluation item E31 is defined by a combination of categories selected from among speed ranges of the leaning vehicle X, driving scenes of the leaning vehicle X, and operations of the leaning vehicle X, during straight-line travel, for example. The speed ranges of the straight-line-travel-detailed-evaluation item E31 are divided into, for example, low speed, general road, and expressway. For example, the driving scenes of the straight-line-travel-detailed-evaluation item E31 are divided into various categories, such as straight-line acceleration, straight-line deceleration, and emergency action during straight-line travel, for each speed range. For example, the operations of the straight-line-travel-detailed-evaluation item E31 are divided into various categories, such as appropriate load distribution, keeping the vehicle body upright, load balance to avoid front lock and rear lift, and firm knee grip, for each driving scene.

Turning-travel-detailed-evaluation item E32 is an evaluation item for evaluating a predetermined physical quantity measured during turning travel and included in the time-series travel data D1 of the leaning vehicle X, based on a predetermined evaluation index, in order to evaluate the driver's driving skill as exhibited during the turning travel of the leaning vehicle X. The turning-travel-detailed-evaluation item E32 is stored in the memory 20. The turning-travel-detailed-evaluation item E32 is defined by a combination of categories selected from among speed ranges of the leaning vehicle X, driving scenes of the leaning vehicle X, and operations of the leaning vehicle X, during turning travel, for example.

As shown in FIG. 7, straight-line-travel-detailed-evaluation-related information A31 is information that relates to an evaluation of the driver's driving skill and is set for each straight-line-travel-detailed-evaluation item E31. The straight-line-travel-detailed-evaluation-related information A31 includes comments on the driver's driving skill during straight-line travel. The straight-line-travel-detailed-evaluation-related information A31 is stored in the memory 20 (see FIG. 2).

Turning-travel-detailed-evaluation-related information A32 is information that relates to an evaluation of the driver's driving skill and is set for each turning-travel-detailed-evaluation item E32. The turning-travel-detailed-evaluation-related information A32 includes comments on the driver's driving skill during turning travel. The turning-travel-detailed-evaluation-related information A32 is stored in the memory 20.

The straight-line-travel-detailed-evaluation-related information A31 and the turning-travel-detailed-evaluation-related information A32 each include at least two of information related to a speed range of the leaning vehicle X, a driving scene of the leaning vehicle X, or an operation of the leaning vehicle X. In other words, the straight-line-travel-detailed-evaluation-related information A31 includes information corresponding to evaluation contents of its corresponding straight-line-travel-detailed-evaluation item E31. The turning-travel-detailed-evaluation-related information A32 includes information corresponding to evaluation contents of its corresponding turning-travel-detailed-evaluation item E32.

For example, when the straight-line-travel-simple-evaluation-related information A11, the turning-travel-simple-evaluation-related information A12, the straight-line-travel-detailed-evaluation-related information A31, and the turning-travel-detailed-evaluation-related information A32 include the information related to a speed range, the information related to a driving scene of the leaning vehicle X, and the information related to an operation of the leaning vehicle X, these information types A11, A12, A31, and A32 include information related to an evaluation (excellent, or needs improvement/caution, etc.) for an operation (appropriate weight distribution, keeping the vehicle body upright, load balance to avoid front lock and rear lift, firm knee grip, etc.) performed on the leaning vehicle X in a predetermined travel state (straight-line acceleration, straight-line deceleration, emergency action during straight-line travel, turning travel, U-turn, etc.) in a speed range (low speed, general road, expressway) in which the leaning vehicle X is traveling.

For example, the straight-line-travel-simple-evaluation-related information A11 and the straight-line-travel-detailed-evaluation-related information A31 include comments such as “During straight-line acceleration (driving scene) on general roads (speed range), appropriate weight distribution (operation) is achieved (evaluation)”. The turning-travel-simple-evaluation-related information A12 and the turning-travel-detailed-evaluation-related information A32 include comments such as “During turning travel (driving scene) at low speeds (speed range), the driver is unable to maintain a firm knee grip (operation) (evaluation)”

As shown in FIG. 7, the straight-line-travel-detailed-evaluation-related information A31 is information that relates to an evaluation of the driver's driving skill and is set for each straight-line-travel-detailed-evaluation item E31. The straight-line-travel-detailed-evaluation-related information A31 includes comments on the driver's driving skill during straight-line travel. The straight-line-travel-detailed-evaluation-related information A31 is stored in the memory 20 (see FIG. 2). The straight-line-travel-detailed-evaluation-related information A31 includes straight-line-travel-detailed-evaluation-related information A31H that indicates a high evaluation and straight-line-travel-detailed-evaluation-related information A31L that indicates a low evaluation according to a predetermined evaluation index, for each straight-line-travel-detailed-evaluation item E31.

The turning-travel-detailed-evaluation-related information A32 is information that relates to an evaluation of the driver's driving skill and is set for each turning-travel-detailed-evaluation item E32. The turning-travel-detailed-evaluation-related information A32 includes comments on the driver's driving skill during turning travel. The turning-travel-detailed-evaluation-related information A32 is stored in the memory 20. The turning-travel-detailed-evaluation-related information A32 includes turning-travel-detailed-evaluation-related information A32H that indicates a high evaluation and turning-travel-detailed-evaluation-related information A32L that indicates a low evaluation according to a predetermined evaluation index, for each turning-travel-detailed-evaluation item E32.

The straight-line-travel-detailed-evaluation item E31 has a threshold value for selecting either the straight-line-travel-detailed-evaluation-related information A31H that indicate a high evaluation, or the straight-line-travel-detailed-evaluation-related information A31L that indicates a low evaluation, according to a predetermined evaluation index, based on the evaluation result. For example, in the straight-line-travel-detailed-evaluation item E31 having a threshold value for acceleration and deceleration values during straight-line travel of the leaning vehicle X, the straight-line-travel-detailed-evaluation-related information A31H is assigned to an evaluation result that is higher than the threshold value, and the straight-line-travel-detailed-evaluation-related information A31L is assigned to an evaluation result that is less than the threshold value.

Similarly, in the turning-travel-detailed-evaluation item E32 having a threshold value, the turning-travel-detailed-evaluation-related information A32H is assigned to an evaluation result that is higher than the threshold value, and the turning-travel-detailed-evaluation-related information A32L is assigned to an evaluation result that is less than the threshold value.

As shown in FIGS. 2, 5, 6, and 7, the detailed evaluator 14 of the travel-data-processing device 1A evaluates a predetermined physical quantity included in the straight-line-travel data D1s based on a predetermined evaluation index, for each of the plurality of straight-line-travel-detailed-evaluation items E31. For each of the plurality of straight-line-travel-detailed-evaluation items E31, if an evaluation result of the straight-line travel detailed evaluation item E31 is higher than a threshold value, the detailed evaluator 14 assigns the straight-line-travel-detailed-evaluation-related information A31H to the evaluation result, and if an evaluation result of the straight-line-travel-detailed-evaluation item E31 is less than the threshold value, the detailed evaluator 14 assigns the straight-line-travel-detailed-evaluation-related information A31L to the evaluation result.

The detailed evaluator 14 evaluates a predetermined physical quantity included in the turning travel data D1t based on a predetermined evaluation index, for each of the plurality of turning-travel-detailed-evaluation items E32. For each of the plurality of turning-travel-detailed-evaluation items E32, if an evaluation result of the turning-travel-detailed-evaluation item E32 is higher than a threshold value, the detailed evaluator 14 assigns the turning-travel-detailed-evaluation-related information A32H to the evaluation result, and if an evaluation result of the turning-travel-detailed-evaluation item E32 is less than the threshold value, the detailed evaluator 14 assigns the turning-travel-detailed-evaluation-related information A32L to the evaluation result.

Next, the detailed evaluator 14 selects detailed evaluation items E3 as items for which evaluation results satisfying a predetermined condition have been obtained, from among the plurality of straight-line-travel-detailed-evaluation items E31 and the plurality of turning-travel-detailed-evaluation items E32. The detailed evaluator 14 selects, from the memory 20, one of the straight-line-travel-detailed-evaluation-related information A31L, the straight-line-travel-detailed-evaluation-related information A31H, the turning-travel-detailed-evaluation-related information A32L, or the turning-travel-detailed-evaluation-related information A32H, as assigned to the evaluation results of the selected detailed-evaluation items E3.

In this case, the detailed evaluator 14 selects the detailed evaluation items E3 so that they includes either the straight-line-travel-detailed-evaluation-related information A31H or the turning-travel-detailed-evaluation-related information A32H, each assigned to an evaluation result that is higher than its corresponding threshold value, and either the straight-line-travel-detailed-evaluation-related information A31L or the turning-travel-detailed-evaluation-related information A32L, each assigned to an evaluation result that is less than its corresponding threshold value. In other words, the detailed evaluator 14 selects a plurality of detailed evaluation items E3 from among the detailed evaluation items E3 for which evaluation results satisfying the predetermined condition have been obtained, so that both high-evaluation comments and low-evaluation comments are included.

As shown in FIGS. 6 and 7, the detailed evaluator 14 evaluates, for example, an evaluation item for the degree of knee grip in a straight-line deceleration scene on a general road as the speed range, based on the straight-line-travel data DIs. The detailed evaluator 14 outputs either the straight-line-travel-detailed-evaluation-related information A31L or the straight-line-travel-detailed-evaluation-related information A31H, which is assigned to the evaluation result, to the output section 15.

In the configuration described above, the detailed evaluation items E3 are selected to include both high-evaluation comments and low-evaluation comments according to predetermined evaluation indices, in order to encourage improvement in the driver's driving skills while suppressing the decline in the driver's motivation to improve driving skills. This enables a configuration that outputs detailed-evaluation-related information A3 on the driving skills to encourage improvement in the driving skills of the driver of the leaning vehicle X, wherein the decrease in design flexibility of hardware resources, such as the travel data processor 10 and the memory 20, can be suppressed.

### Variation of Second Embodiment

As shown in FIGS. 6 and 7, the detailed evaluator 14 may select the detailed evaluation items E3 using a predetermined condition, that is, whether evaluation results of the plurality of straight-line-travel-detailed-evaluation items E31 and the plurality of turning-travel-detailed-evaluation items E32 are classified as high or low according to predetermined evaluation indices. In other words, the detailed evaluator 14 outputs detailed-evaluation-related information A3 corresponding to a detailed evaluation item E3 with a high evaluation result according to a predetermined evaluation index, and detailed-evaluation-related information A3 corresponding to a detailed evaluation item E3 with a low evaluation result according to a predetermined evaluation index, from among the plurality of straight-line-travel-detailed-evaluation items E31 and the plurality of turning-travel-detailed-evaluation items E32.

For example, the detailed evaluator 14 outputs detailed-evaluation-related information A3 corresponding to a detailed evaluation item E3 with the highest evaluation result according to a predetermined evaluation index, and detailed evaluation-related information A3 corresponding to a detailed evaluation item E3 with the lowest evaluation result according to a predetermined evaluation index, from among the plurality of straight-line-travel-detailed-evaluation items E31 and the plurality of turning-travel-detailed-evaluation items E32.

As shown in FIG. 6, it is assumed that, among the plurality of straight-line-travel-detailed-evaluation items E31, the detailed evaluator 14 evaluates an evaluation item regarding the degree of knee grip in a straight-line deceleration scene on a general road as the speed range, as having the lowest evaluation result. In addition, it is assumed that, among the plurality of turning-travel-detailed-evaluation items E32, the detailed evaluator 14 evaluates an evaluation item regarding smooth acceleration and deceleration in a turning scene on a corner on a general road as the speed range, as having the highest evaluation result. In this case, the detailed evaluator 14 selects the evaluation item regarding the degree of knee grip in a straight-line deceleration scene on a general road, and the evaluation item regarding smooth acceleration and deceleration in a turning scene on a corner on a general road. Furthermore, the detailed evaluator 14 outputs straight-line-travel-detailed-evaluation-related information A31 and turning-travel-detailed-evaluation-related information A32 corresponding to the selected evaluation items, respectively, to the output section 15 (see FIG. 7).

The detailed evaluator 14 is configured to output detailed-evaluation-related information A3 to include detailed-evaluation-related information A3 corresponding to a detailed evaluation item E3 with a high evaluation result according to a predetermined evaluation index, and detailed-evaluation-related information A3 corresponding to a detailed evaluation item E3 with a low evaluation result according to a predetermined evaluation index, from among the plurality of straight-line-travel-detailed-evaluation items E31 and the plurality of turning-travel-detailed-evaluation items E32.

For example, the detailed evaluator 14 may output two or more pieces of detailed-evaluation-related information A3 corresponding to detailed evaluation items E3 with a high evaluation result according to predetermined evaluation indices, and two or more pieces of detailed-evaluation-related information A3 corresponding to detailed evaluation items E3 with a low evaluation result according to predetermined evaluation indices, from among the plurality of straight-line-travel-detailed-evaluation items E31 and the plurality of turning-travel-detailed-evaluation items E32.

For example, the detailed evaluator 14 may output, from among the plurality of straight-line-travel-detailed-evaluation items E31 and the plurality of turning-travel-detailed-evaluation items E32, two or more pieces of detailed-evaluation-related information A3 corresponding to predetermined evaluation items (e.g., evaluation items related to straight-line acceleration) out of the evaluation items E3 with a high evaluation result according to predetermined evaluation indices, and two or more pieces of detailed-evaluation-related information A3 corresponding to predetermined evaluation items (e.g., evaluation items related to turning acceleration) out of the detailed evaluation items E3 with a low evaluation result according to predetermined evaluation indices.

In addition, the travel-data-processing device 1A may cause the simple evaluator 13 to select straight-line-travel-simple-evaluation-related information A11 and turning-travel-simple-evaluation-related information A12 to include simple-evaluation-related information A1 corresponding to a simple evaluation item E1 with a high evaluation result according to a predetermined evaluation index and simple-evaluation-related information A1 corresponding to a simple evaluation item E1 with a low evaluation result according to a predetermined evaluation index (see FIG. 1) among the evaluation results of the straight-line-travel-simple-evaluation items E11 and the evaluation results of the turning-travel-simple-evaluation items E12.

The travel-data-processing device 1A configured in this manner outputs simple-evaluation-related information A1 that indicates a high evaluation and simple-evaluation-related information A1 that indicates a low evaluation according to predetermined evaluation indices, or detailed-evaluation-related information A3 that indicate a high evaluation and detailed-evaluation-related information A3 that indicate a low evaluation according to predetermined evaluation indices, for the straight-line-travel-simple-evaluation item E11 and the turning-travel-simple-evaluation item E12, or the plurality of straight-line-travel-detailed-evaluation items E31 and the plurality of turning-travel-detailed-evaluation items E32.

In the configuration described above, among the straight-line-travel-simple-evaluation items E11 and the turning-travel-simple-evaluation items E12, or the plurality of straight-line-travel-detailed-evaluation items E31 and the plurality of turning-travel-detailed-evaluation items E32, simple-evaluation-related information A1 or detailed-evaluation-related information A3 corresponding to a simple evaluation item E1 or a detailed-evaluation item E3, respectively, for which the driver's driving skill is evaluated as high according to a predetermined evaluation index, as well as simple-evaluation-related information A1 or detailed-evaluation-related information A3 corresponding to a simple evaluation item E1 or a detailed-evaluation item E3, respectively, for which the driver's driving skill is evaluated as low according to a predetermined evaluation index, are output Therefore, the driver can understand the aspects of his/her driving skills that require improvement as well as those in which his/her driving skills excel in the simple evaluation items E1 or the detailed evaluation items E3, which serves as technical advice to the driver and also enables suppression of the decline in the driver's motivation to improve driving skills.

In addition, the amount of data processed by the travel data processor 10 is reduced because its output is limited to the simple-evaluation-related information A1 corresponding to the simple evaluation item E1 with a high evaluation result and the simple-evaluation-related information A1 corresponding to the simple evaluation item E1 with a low evaluation result, or the detailed-evaluation-related information A3 corresponding to the detailed evaluation item E3 with a high evaluation result and the detailed-evaluation-related information A3 corresponding to the detailed evaluation item E3 with a low evaluation result. This enables a configuration that outputs the simple-evaluation-related information A1 or the detailed-evaluation-related information A3 for encouraging improvement in the driving skills of the driver of the leaning vehicle X, wherein the decrease in design flexibility of hardware resources, such as the travel data processor 10 and the memory 20, can be suppressed.

### Third Embodiment

### (Travel Data-Measurement Device)

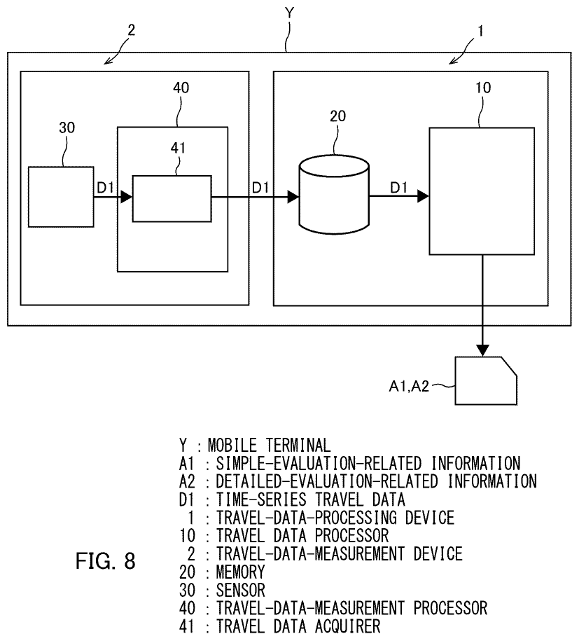

With reference to FIG. 8, a travel-data-measurement device 2 according to a third embodiment of the present teaching will be described. FIG. 8 is a schematic view showing a configuration in which the travel-data-processing device 1 and the travel-data-measurement device 2 are built into the mobile terminal Y. In this embodiment, the travel data processor 10 is, for example, configured without a function for acquiring the time-series travel data D1 for at least one driving cycle from the sensor 30.

The travel-data-measurement device 2 measures the time-series travel data D1 of the leaning vehicle X. The travel-data-measurement device 2 is built into the mobile terminal Y mounted on the leaning vehicle X. The travel-data-processing device is built into the mobile terminal Y. The travel-data-measurement device 2 has the sensor 30 and a travel-data-measurement processor (processor for measuring travel data) 40.

The sensor 30 is a detection device configured to be mountable on the leaning vehicle X and detect physical quantities related to a behavior of the leaning vehicle X. The sensor 30 is built into the mobile terminal Y mounted on the leaning vehicle X. The sensor 30 includes a sensor capable of detecting speed, acceleration along the three axes, i.e., in the front-rear direction, the up-down direction, and the left-right direction, with respect to the sensor 30, and angular velocity about the three coordinate axes (roll axis, yaw axis, and pitch axis), regarding the leaning vehicle X. In the following embodiment, the mobile terminal Y is mounted on the leaning vehicle X in a pre-specified mounting posture.

The travel-data-measurement processor 40 is a central processing unit used in computers, for example. The travel-data-measurement processor 40 is built into the mobile terminal Y mounted on the leaning vehicle X. The travel-data-measurement processor 40 is electrically connected to the memory 20 and the sensor 30. Although not specifically shown, the travel-data-measurement processor 40 acquires the time-series travel data D1 for at least one driving cycle output from the sensor 30, and stores the acquired time-series travel data D1 in the memory 20 of the travel-data-processing device 1. The travel-data-measurement processor 40 has a travel data acquirer 41.

The travel data acquirer 41 acquires the time-series travel data D1 output from the sensor 30 attached to the leaning vehicle X and stores it in the memory 20 of the travel-data-processing device 1. The travel data acquirer 41 acquires the speed data D21, the acceleration data D22, and the angular velocity data D23 included in the time-series travel data D1 of the leaning vehicle X, and stores them in the memory 20 (see FIG. 1).

The travel data acquirer 41 may acquire data other than the speed data D21, the acceleration data D22, and the angular velocity data D23 included in the time-series travel data D1. For example, the travel data acquirer 41 may acquire, from the sensor 30, physical quantities related to a behavior of the leaning vehicle X other than the speed data D21, the acceleration data D22, and the angular velocity data D23 as time-series travel data D1, and store them in the memory 20. Specifically, the travel data acquirer 41 may acquire, from the sensor 30, at least one of acceleration along the three axes, angle about the three axes, or angular acceleration about the three axes from the time-series travel data D1 and store it in the memory 20.

The travel-data-measurement processor 40 acquires travel data representing the physical quantities related to the behavior of the leaning vehicle X output from the sensor 30. The travel-data-measurement processor 40 outputs the acquired travel data in a format that is accessible to the travel data processor 10.

As described above, the travel-data-measurement device 2 is built into the mobile terminal Y that incorporates the travel data processing device 1. The travel-data-measurement device 2 is configured to be capable of outputting the time-series travel data D1 to the travel data processor 10 of the travel-data-processing device 1. Therefore, the mobile terminal Y, which has the travel-data-processing device 1 and the travel-data-measurement device 2 built in, can output the simple-evaluation-related information A1 and the detailed-evaluation-related information A2 regarding evaluations of the driver's driving skills, without outputting the time-series travel data D1 externally.

The travel data processor 10 evaluates the plurality of straight-line travel-detailed evaluation items E21 and the plurality of turning-travel-detailed evaluation items E22 based on the time-series travel data D1 acquired from the travel-data-measurement processor 40 (see FIG. 1). In other words, the travel-data-measurement processor 40 handles acquisition of the time-series travel data D1, while the travel data processor 10 handles processing of the time-series travel data D1. This makes it possible to suppress the decrease in design flexibility of hardware resources, such as the travel data processor 10 and the memory 20.

### Variation of Third Embodiment

### (Travel-Data-Measurement-Processing Device)

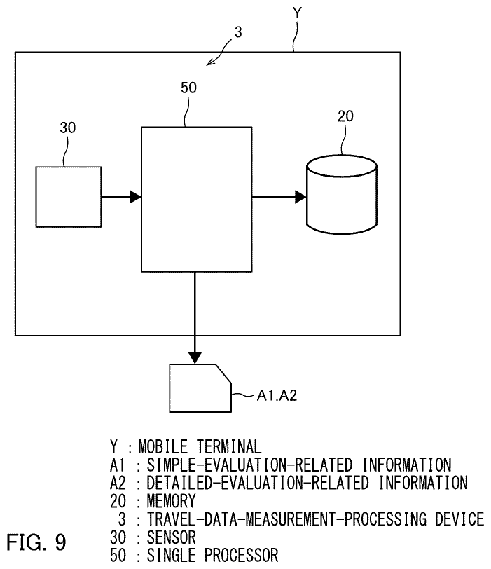

With reference to FIG. 9, a travel-data-measurement-processing device 3 according to a variation of the third embodiment of the present teaching will be described. FIG. 9 is a schematic view showing a configuration of the travel-data-measurement-processing device 3 in which the travel data processor 10 and the travel-data-measurement processor 40 are configured as a single processor 50.

The travel data processor 10 of the travel-data-processing device 1 and the travel-data-measurement processor 40 of the travel-data-measurement device 2, which are built into the mobile terminal Y, may be configured as the single processor 50. In other words, the mobile terminal Y is configured as the travel-data-measurement-processing device 3 that integrates the travel-data-processing device 1 and the travel-data-measurement device 2.

The travel-data-measurement-processing device 3 has the memory 20, the sensor 30, and the single processor 50. The travel-data-measurement-processing device 3 is housed in the mobile terminal Y.

The single processor 50 has the functions provided by the travel data processor 10, that is, the functions of the travel data acquirer 11 (travel data acquirer 41), the data segmenting section 12, the simple evaluator 13, the detailed evaluator 14, and the output section 15. The single processor 50 is housed in the mobile terminal Y mounted on the leaning vehicle X. The single processor 50 also has the function provided by the travel-data-measurement processor 40, that is, the function of the travel data acquirer 41. In other words, the single processor 50 has the functions of the travel data processor 10 and the travel-data-measurement processor 40. The single processor 50 is electrically connected to the memory 20 and the sensors 30.

The travel-data-measurement-processing device 3, configured as described above, has the functions of the travel-data-processing device 1 and the travel-data-measurement device 2. The travel-data-measurement-processing device 3 outputs the simple-evaluation-related information A1 based on the evaluation results of the straight-line-travel-simple-evaluation item E11 and the turning-travel-simple-evaluation item E12. In addition, the travel-data-measurement-processing device 3 outputs the detailed-evaluation-related information A2 based on the evaluation results of the plurality of straight-line-travel-detailed-evaluation items E21 and the plurality of turning-travel-detailed-evaluation items E22. In this manner, the evaluation-related information on the driving skills to encourage improvement in the driving skills of the driver of the leaning vehicle X can be output from multiple perspectives.

### Fourth Embodiment

### (Travel-Data-Measurement Device and Travel-Data-Processing Device)

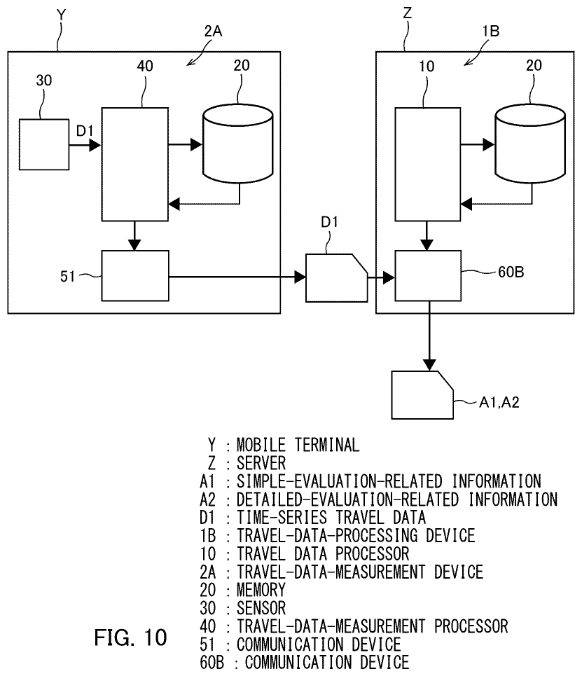

With reference to FIG. 10, a travel-data-processing device 1B and a travel-data-measurement device 2A according to a fourth embodiment of the present teaching will be described. FIG. 10 is a schematic view showing a configuration in which the travel-data-processing device 1B and the travel-data-measurement device 2A are electrically connected by communication devices 51 and 60A.

The travel-data-processing device 1B performs computational processing outside the mobile terminal Y. The travel-data-processing device 1B acquires the time-series travel data D1 from the travel-data-measurement device 2A built into the mobile terminal Y. The travel-data-processing device 1B has the travel data processor 10, the memory 20, and the communication device 60B. The travel data processor 1B is built into a server Z that is an arithmetic processing unit outside the mobile terminal Y.

The communication device 60B is capable of acquiring the time-series travel data D1 output from the travel-data-measurement device 2A. The communication device 60B is also capable of outputting the time-series travel data D1 subjected to the computational processing outside the travel-data-processing device 1B, in a format that is accessible to the travel-data-measurement device 2A. In other words, the communication device 60B is capable of outputting the time-series travel data D1 subjected to the computational processing to the travel-data-measurement device 2A.

The travel data processor 10 is electrically connected to the memory 20 and the communication device 60B. The travel data processor 10 outputs the time-series travel data D1 outside the travel-data-processing device 1B via the communication device 60B, in a format that is accessible to the travel-data-measurement processor 40.

The travel-data-measurement device 2A measures the time-series travel data D1 within the mobile terminal Y. The travel-data-measurement device 2A outputs the time-series travel data D1 to the travel-data-processing device 1B that performs the computational processing outside the mobile terminal Y. The travel-data-measurement device 2A has the memory 20, the sensor 30, the travel-data-measurement processor 40, and the communication device 51. The travel-data-measurement device 2A is built into the mobile terminal Y.

The communication device 51 is capable of outputting the time-series travel data D1 stored in the memory 20 or the time-series travel data D1 detected by the sensor 30, outside the travel-data-measurement device 2A, in a format that is accessible to the travel data processor 10. In other words, the communication device 51 is capable of outputting the time-series travel data D1 to the travel-data-processing device 1B.

The travel-data-measurement processor 40 is electrically connected to the memory 20, the sensor 30, and the communication device 51. The travel-data-measurement processor 40 outputs the time-series travel data D1 outside the travel-data-measurement device 2A via the communication device 51, in a format that is accessible to the travel data processor 10.

With this configuration, the time-series travel data D1 acquired by the travel-data-measurement device 2A built into the mobile terminal Y is processed by the travel-data-processing device 1 configured on the server or a similar device located outside the mobile terminal Y. This makes it possible to suppress the decrease in design flexibility of hardware resources, such as the travel data processor 10 and the memory 20.

This makes it possible to suppress a decrease in the design flexibility of hardware resources such as the travel data processor 10 and memory 20.

### OTHER EMBODIMENTS

The embodiments of the present teaching have been described above, but the above-described embodiments are merely illustrative examples of how the present teaching may be implemented. Therefore, the present teaching is not limited to the above-described embodiments and the above-described embodiments can be appropriately modified and implemented without departing from the gist of the teaching.

In the above-described embodiments, the travel data processor 10 evaluates the respective predetermined physical quantities included in the time-series travel data D1 based on the predetermined evaluation indices for the plurality of straight-line-travel-detailed-evaluation items E21 and the plurality of turning-travel-detailed-evaluation items E22. Alternatively, the travel data processor may evaluate the simple evaluation items and the detailed evaluation items through relative evaluation with respect to a predetermined population. The travel data processor evaluates the simple evaluation items and the detailed evaluation items based on their positions (ranking) and the like within the predetermined population. In other words, the travel data processor evaluates the driver's driving skills by relative values in the predetermined population.

The travel data processor 10 can, for example, evaluate the driving skills of the driver relative to a population to which the driver belongs, and also evaluate the driving skills of the driver relative to various populations, such as populations with higher driving skills than the driver, as well as populations segmented by gender, age, region, and the like.

In the above-described embodiments, the simple evaluation items E1 and the detailed evaluation items E2 are evaluated according to the predetermined evaluation indices. However, the predetermined evaluation indices for the simple evaluation items and the detailed evaluation items may be set arbitrarily. The predetermined evaluation indices for the simple evaluation items and the detailed evaluation items may be set according to the driver to be evaluated, such as gender, age, region, the driver's driving skill level, and the like.

In the above-described embodiments, the travel data is detected as time-series data. Alternatively, the travel data may not be time-series data.

In the above-described embodiments, as the simple evaluation items E1, one evaluation item that the driver wishes to have evaluated is set for each of straight-line travel and turning travel of the leaning vehicle X. Alternatively, as the simple evaluation items, a plurality of evaluation items may be set for each of straight-line travel and turning travel of the mobile body.

In the above-described embodiments, as the simple evaluation items E1, a predetermined evaluation item is set for each of straight-line travel and turning travel of the leaning vehicle X. Alternatively, as the simple evaluation items, an evaluation item may be set arbitrarily by the driver for each of straight-line travel and turning travel of the mobile body.

In the above-mentioned embodiment, as the simple evaluation items E1 and the detailed evaluation items E2, a predetermined evaluation item is set for each of straight-line travel and turning travel of the leaning vehicle X. Alternatively, the simple evaluation items and the detailed evaluation items may be evaluation items other than those regarding straight-line travel and turning travel of the mobile body.

In the above-described embodiments, for each of the simple-evaluation-related information A1 corresponding to the simple evaluation items E1 and the detailed-evaluation-related information A2 corresponding to the detailed evaluation items E2, the number of displayed items is two. Alternatively, for each of the simple-evaluation-related information and the detailed-evaluation-related information, the number of displayed items may be either one or three or more.

In the above-described embodiments, the detailed-evaluation-related information A3 corresponding to the detailed evaluation item E3 with a high evaluation result and the detailed-evaluation-related information A3 corresponding to the detailed evaluation item E3 with a low evaluation result, according to predetermined evaluation indices, are displayed. Alternatively, the detailed-evaluation-related information to be output may be limited to that corresponding to the detailed evaluation item with a high evaluation result according to a predetermined evaluation index. Furthermore, the detailed-evaluation-related information to be output may be limited to that corresponding to the detailed evaluation item with a low evaluation result according to a predetermined evaluation index.

### REFERENCE SIGNS LIST

1, 1A, 1B travel-data-processing device
2, 2A travel-data-measurement device
3 travel-data-measurement-processing device
10 travel data processor (processor for processing travel data)
11, 41 travel data acquirer
12 data segmenting section
13 simple evaluator
14 detailed evaluator
15 output section
20 memory
30 sensor
40 travel-data-measurement processor (processor for measuring travel data)
50 single processor
51, 60B communication device
E1 simple evaluation item
E11 straight-line-travel-simple-evaluation item (simple evaluation item for straight-line travel)
E12 turning-travel-simple-evaluation item (simple evaluation item for turning travel)
E2, E3 detailed evaluation item E21, E31 straight-line-travel-detailed-evaluation item (detailed evaluation item for straight-line travel)
E22, E32 turning-travel-detailed-evaluation item (detailed evaluation item for turning travel)
A1 simple-evaluation-related information
A11 straight-line-travel-simple-evaluation-related information (simple evaluation-related information for straight-line travel)
A12 turning-travel-simple-evaluation-related information (simple evaluation-related information for turning travel)
A2, A3 detailed-evaluation-related information
A21, A21H, A21L, A31, A31H, A31L
   straight-line-travel-detailed-evaluation-related information (detailed evaluation-related information for straight-line travel)
A22, A32, A32H, A32L
   turning-travel-detailed-evaluation-related information (detailed evaluation-related information for turning travel)
D1 time-series travel data
D1s straight-line-travel data
D1t turning travel data
D21 speed data
D22 acceleration data
D23 angular velocity data
D24 position data
S1, S2, S3 screen
G1, G2 graph
X leaning vehicle
Y mobile terminal
Z server

1. A travel-data-processing device, comprising:
a memory configured to store
a plurality of pieces of straight-line-travel-detailed-evaluation-related information related to evaluations of a plurality of straight-line-travel-detailed-evaluation items, for evaluation of driving skills of a driver as exhibited during straight-line travel of a mobile body, and
a plurality of pieces of turning-travel-detailed-evaluation-related information related to evaluations of a plurality of turning-travel-detailed-evaluation items, for evaluation of the driving skills of the driver as exhibited during turning travel of the mobile body; and
a travel data processor configured to output at least one of the plurality of pieces of straight-line-travel-detailed-evaluation-related information or the plurality of pieces of turning-travel-detailed-evaluation-related information, based on an output of a detection device configured to be mounted on the mobile body and to detect a physical quantity related to a behavior of the mobile body, wherein
the memory is further configured to store
a plurality of pieces of straight-line-travel-simple-evaluation-related information related to evaluations of a plurality of straight-line-travel-simple-evaluation items, for evaluation of the driving skills of the driver as exhibited during the straight-line travel of the mobile body, and
a plurality of pieces of turning-travel-simple-evaluation-related information related to evaluations of a plurality of turning-travel-simple-evaluation items, for evaluation of the driving skills of the driver as exhibited during the turning travel of the mobile body, and
the travel data processor is further configured to:
acquire travel data representing the physical quantity related to the behavior of the mobile body output from the detection device, and segment the travel data into straight-line-travel data for the straight-line travel of the mobile body and turning-travel data for the turning travel of the mobile body,
evaluate a predetermined straight-line-travel-simple-evaluation item based on the straight-line-travel data, and output straight-line-travel-simple-evaluation-related information selected from among the plurality of pieces of the straight-line-travel-simple-evaluation-related information stored in the memory, based on the evaluation result,
evaluate a predetermined turning-travel-simple-evaluation item based on the turning travel data, and output turning-travel-simple-evaluation-related information selected from among the plurality of pieces of the turning-travel-simple-evaluation-related information stored in the memory, based on the evaluation result,
evaluate the plurality of the straight-line-travel-detailed-evaluation items for the straight-line travel of the mobile body based on the straight-line-travel data,
evaluate the plurality of the turning-travel-detailed-evaluation items for the turning travel of the mobile body based on the turning travel data, and
select a detailed evaluation item, with an evaluation result that satisfies a predetermined condition, among the plurality of the straight-line-travel-detailed-evaluation items and the plurality of the turning-travel-detailed evaluation items, and output a piece of detailed-evaluation-related information, from among the plurality of pieces of the straight-line-travel-detailed-evaluation-related information and the plurality of pieces of the turning-travel-detailed-evaluation-related information stored in the memory, based on the evaluation result of the selected detailed evaluation item.

2. The travel-data-processing device according to claim 1, wherein the travel data processor is further configured to
select the straight-line-travel-simple-evaluation-related information and the turning-travel-simple-evaluation-related information to include simple-evaluation-related information that indicates a high evaluation and simple-evaluation-related information that indicates a low evaluation, according to predetermined evaluation indices, based on evaluation results of the straight-line-travel-simple-evaluation items and evaluation results of the turning-travel-simple-evaluation items, or
select the detailed evaluation items to include detailed-evaluation-related information that indicates a higher evaluation than a threshold value and detailed-evaluation-related information that indicates a lower evaluation than the threshold value, according to predetermined evaluation indices, based on evaluation results that satisfy the predetermined condition among the evaluation results of the plurality of the straight-line-travel-detailed-evaluation items and the evaluation results of the plurality of the turning-travel-detailed evaluation items.

3. The travel-data-processing device according to claim 1, wherein
the memory is further configured to store
straight-line-travel-detailed-evaluation-related information that indicates a higher evaluation than a threshold value thereof and straight-line travel-detailed-evaluation-related information that indicates a lower evaluation than the threshold value thereof according to a predetermined evaluation index, for each of the straight-line-travel-detailed-evaluation items, and
turning-travel-detailed-evaluation-related information that indicates a higher evaluation than a threshold value thereof and turning-travel-detailed-evaluation-related information that indicates a lower evaluation than the threshold value thereof according to a predetermined evaluation index, for each of the turning-travel-detailed-evaluation items.

4. The travel-data-processing device according to claim 1, wherein the predetermined condition is defined as a highest evaluation and a lowest evaluation, among evaluation results of the plurality of the straight-line-travel-detailed-evaluation items and evaluation results of the plurality of the turning-travel-detailed-evaluation items.

5. The travel-data-processing device according to claim 1, wherein the straight-line-travel-simple-evaluation-related information, the turning-travel-simple-evaluation-related information, the straight-line-travel-detailed-evaluation-related information, and the turning-travel-detailed-evaluation-related information include at least two types of information selected from among a speed range of the mobile body, a driving scene of the mobile body, or an operation of the mobile body.

6. The travel-data-processing device according to claim 1, wherein the travel data processor is configured to evaluate the plurality of the straight-line-travel-detailed-evaluation items and the plurality of the turning-travel-detailed-evaluation items through relative evaluation with respect to a predetermined population, based on the travel data.

7. The travel-data-processing device according to claim 1, further comprising a communication device for external communications, wherein
the travel data processor is configured to acquire the travel data via the communication device.

8. A travel-data-measurement device configured to measure travel data of the mobile body to be processed by the travel-data-processing device according to claim 1, the travel-data-measurement device comprising:
the detection device configured to be mountable on the mobile body and to detect the physical quantity related to the behavior of the mobile body; and
a travel-data-measurement processor configured to acquire the travel data from the detection device, and to output the acquired travel data in a format that is accessible to the travel data processor of the travel-data-processing device.

9. The travel-data-measurement device according to claim 8, further comprising a communication device for external communications, wherein
the travel-data-measurement processor is configured to output the acquired travel data via the communication device.

10. A travel-data-measurement-processing device, comprising:
a travel-data-processing device, which includes:
a memory configured to store
a plurality of pieces of straight-line-travel-detailed-evaluation-related information related to evaluations of a plurality of straight-line-travel-detailed-evaluation items, for evaluation of driving skills of a driver as exhibited during straight-line travel of a mobile body, and
a plurality of pieces of turning-travel-detailed-evaluation-related information related to evaluations of a plurality of turning-travel-detailed-evaluation items, for evaluation of the driving skills of the driver as exhibited during turning travel of the mobile body; and
a travel data processor configured to output at least one of the plurality of pieces of straight-line-travel-detailed-evaluation-related information or the plurality of pieces of turning-travel-detailed-evaluation-related information, based on an output of a detection device configured to be mounted on the mobile body and to detect a physical quantity related to a behavior of the mobile body, wherein
the memory is further configured to store
a plurality of pieces of straight-line-travel-simple-evaluation-related information related to evaluations of a plurality of straight-line-travel-simple-evaluation items, for evaluation of the driving skills of the driver as exhibited during the straight-line travel of the mobile body, and
a plurality of pieces of turning-travel-simple-evaluation-related information related to evaluations of a plurality of turning-travel-simple-evaluation items, for evaluation of the driving skills of the driver as exhibited during the turning travel of the mobile body, and
the travel data processor is further configured to:
acquire travel data representing the physical quantity related to the behavior of the mobile body output from the detection device, and segment the travel data into straight-line-travel data for the straight-line travel of the mobile body and turning-travel data for the turning travel of the mobile body,
evaluate a predetermined straight-line-travel-simple-evaluation item based on the straight-line-travel data, and output straight-line-travel-simple-evaluation-related information selected from among the plurality of pieces of the straight-line-travel-simple-evaluation-related information stored in the memory, based on the evaluation result,
evaluate a predetermined turning-travel-simple-evaluation item based on the turning travel data, and output turning-travel-simple-evaluation-related information selected from among the plurality of pieces of the turning-travel-simple-evaluation-related information stored in the memory, based on the evaluation result,
evaluate the plurality of the straight-line-travel-detailed-evaluation items for the straight-line travel of the mobile body based on the straight-line-travel data,
evaluate the plurality of the turning-travel-detailed-evaluation items for the turning travel of the mobile body based on the turning travel data, and
select a detailed evaluation item, with an evaluation result that satisfies a predetermined condition, among the plurality of the straight-line-travel-detailed-evaluation items and the plurality of the turning-travel-detailed evaluation items, and output a piece of detailed-evaluation-related information, from among the plurality of pieces of the straight-line-travel-detailed-evaluation-related information and the plurality of pieces of the turning-travel-detailed-evaluation-related information stored in the memory, based on the evaluation result of the selected detailed evaluation item; and
a travel-data-measurement device configured to measure the travel data, the travel-data-measurement device including:
the detection device; and
a travel-data-measurement processor, configured to acquire the travel data from the detection device, and to output the acquired travel data in a format that is accessible to the travel data processor, wherein
the travel data processor and the travel-data-measurement processor are configured as a single processor that is electrically connected to the memory and is housed in an enclosure mounted on the mobile body.
